(19) United States
(12) Patent Application Publication
(10) Pub. No.: US 2024/0265429 A1
(43) Pub. Date: Aug. 8, 2024

(54) E-USED DIGITAL ASSETS AND POST-ACQUISITION REVENUE

(71) Applicant: Catch Media, Inc., Douglasville, GA (US)

(72) Inventors: Yaacov Ben-Yaacov, Douglasville, GA (US); Boaz Ben-Yaacov, Douglasville, GA (US); Abraham Lieberman, Modi'in (IL)

(21) Appl. No.: 18/616,211

(22) Filed: Mar. 26, 2024

Related U.S. Application Data
(63) Continuation of application No. 18/089,783, filed on Dec. 28, 2022, now abandoned.
Application No. 18/089,783 is a continuation of application No. 16/507,006, filed on Jul. 9, 2019, now abandoned.
Application No. 16/507,006 is a continuation of application No. 13/403,890, filed on Feb. 23, 2012, now abandoned.
(60) Provisional application No. 61/446,015, filed on Feb. 23, 2011.

(51) Int. Cl. G06Q 30/06; G06Q 20/10; G06Q 40/08

(52) U.S. Cl. CPC G06Q 30/06; G06Q 20/10; G06Q 40/08

(57) ABSTRACT

A computing system including a communication layer, including client web services managing communication with client computers, including a message parser, a message validator, and a message authenticator, and a computing engine layer, including a registrar that (i) registers purchase of a digital asset by a first consumer, (ii) generates a dated record of title to the first consumer for the digital asset, (iii) receives a resale permission message for the digital asset from the first consumer, via the client web services, whereby the permission message is parsed, validated, and authenticated by the client web services, (iv) further registers purchase of the digital asset by a second consumer, and (v) further generates an updated record of title for the digital asset to the second consumer.

### CROSS REFERENCE TO RELATED APPLICATIONS

The present application is a continuation of Applicant's pending U.S. patent application Ser. No. 18/089,783, filed on Dec. 28, 2022, entitled “E-Used Digital Assets and Post-Acquisition Revenue.” U.S. patent application Ser. No. 18/089,783 is a continuation of Applicant's U.S. patent application Ser. No. 16/507,006, filed on Jul. 9, 2019, entitled “E-Used Digital Assets and Post-Acquisition Revenue,” now abandoned. U.S. patent application Ser. No. 16/507,006 is a continuation of Applicant's U.S. patent application Ser. No. 13/403,890, filed on Feb. 23, 2012, entitled “E-Used Digital Assets and Post-Acquisition Revenue,” now abandoned. U.S. patent application Ser. No. 13/403,890 claims priority benefit of Applicant's U.S. Provisional Patent Application No. 61/446,015, filed on Feb. 23, 2011, entitled “E-Used Digital Assets and Post-Acquisition Revenue.” The disclosures of these applications are all hereby incorporated by reference in their entireties.

### TECHNICAL FIELD OF THE INVENTION

The present invention relates to post-acquisition media-related services.

### BACKGROUND OF THE INVENTION

In the market for physical media, there are generally multi-tiered release models. The multiple tiers are controller by publishers of the media, and facilitated through the publishers' distribution channels. For example, in the book publising market, there are traditionally two tiers; namely, (i) a hardcover release, and (ii) a paperback release. In addition to the publisher-controlled two tiers, there exists a third tier, namely (iii) a used book market. It was estimated by Ipsos BOOKTRENDS® in 2002 that the used book market in the United States was a $533 million market, not including college text books. According to that study, the non-college textbook market was expected to grow to above $1 billion by 2010. According to current estimates the used book market has in fact surpassed that $1 billion estimate. The publishers generally resented the used book market as it was seen to canibalize sales of the new book market, and the publishers did not participate in the used book value chain.

In the market for digital media, publishers license digital assets for sale by existing e-tailers through their siloed storefronts. The e-tailers disburse royalty payments to publishers as digital assets are sold. There is no second or third tier opportunity with these consumers.

Conventional home owner's insurance provides coverage for personal belongings, but in many cases it is difficult to accurately register all of a person's belongings. Belongings that change relatively infrequently, such as furniture and appliances, are easier to register accurately. Belongings that frequently change, however, such as media collections, are difficult to register accurately. Moreover, replacement of a lost or stolen media collection is generally much more difficult for a person than replacement of lost or stolen furniture or appliances.

Consider, for example, a person who has accumulated a digital library of, say, 10,000 songs, 100 movies, 150 e-books, 20 audiobooks, 30 console games, and assorted applications for PCs and mobile devices. This library is stored on a variety of media including physical CDS, DVDS, Blu-Ray discs and hard drives. This library may be worth ten thousand dollars, and represent a significant asset for insurance purposes. Yet registering each piece of media content in the collection, and constantly updating the registry as additional content is obtained, is difficult.

### SUMMARY OF THE DESCRIPTION

Aspects of the present invention relate to methods and systems for enabling post-acquisition revenues for digital assets, by providing the technology infra-structure for a wide variety of post-acquisition services. Post-acquisition revenues refer to revenues generated from consumers after their initial purchase of their digital assets. The post-acquisition revenue is allocated between publishers, e-tailers and consumers, and as such represents an opportunity and an incentive for these participants to generate additional revenue from digital assets that have already been sold.

One such post-acquisition revenue opportunity is a market for used digital assets, referred to herein as “e-used assets”. Aspects of the present invention provide a comprehensive e-commerce system for reselling digital assets, and for lending digital assets.

Another such post-acquisition revenue opportunity is a “lending market” for used digital assets, where a consumer registers with a service in order to borrow e-used assets from a library or from other consumers.

For example, aspects of the present invention provide a mechanism for supporting an e-used book market. The present invention enables a second tier for electronic books (“e-books”), wherein e-books can be resold. The second tier enables publishers to control the e-used book market, and to re-monetize an e-book multiple times, after the initial sale of the e-book. The second tier also enables publishers to market the e-book across multiple e-tailers, instead of being limited to the one e-tailer who provides the initial sales. The present invention enables consumers to sell their purchased e-books to other consumers across multiple e-tailers.

Embodiments of the present invention provide a registry of registries, across multiple e-tailers, for initial purchases of digital assets and for subsequent purchases of e-used digital assets. Embodiments of the present invention track sale and resale transactions, and act as a clearinghouse for disparate vendors.

Another post-acquisition revenue opportunity is providing insurance for digital asset collections. Aspects of the present invention provide methods and systems for accurately tracking and appraising a media inventory, and for processing insurance claims for lost or stolen media.

The present invention is of advantage to consumers, who invest substantial money in accumulating personal media collections, by providing them with an accurate registry of their media items and the rights they have thereto, and enabling them to insure their collections against loss and theft. The present invention is of additional advantage to consumers by providing them with a mechanism to resell digital assets that they own, and thereby recoup some of the cost they incurred in purchasing the assets. The present invention is moreover of advantage to consumers by providing them with a mechanism for lending and borrowing digital assets to and from other consumers.

The present invention is also of advantage to insurance companies, by enabling them to insure people's valuable media inventories with accurate appraisal value, and to process claims for lost or stolen media items.

Moreover, the present invention also provides insurers with an easy mechanism to replace lost or stolen media collections. Media may be replaced in the same physical or non-physical form that it had prior to loss or theft; i.e., physical CDs are replaced with physical CDs and computer media files are replaced with computer media files.

The present invention is of advantage to publishers in enabling them to derive additional revenue from a digital asset after the asset has been sold. This revenue may be derived from several sources, including resale of an e-used asset though a different retailer than the one that originally sold the asset.

The present invention is of advantage to e-tailers in allowing them to likewise derive additional revenue from a digital asset after the asset has been sold.

There is thus provided in accordance with an embodiment of the present invention a method for resale of digital assets, including registering purchase of a digital asset by a first consumer via a first e-tailer, for presentation to the first consumer on at least one first device, the digital asset being published by a publisher, wherein an e-tailer sells digital assets published by the publisher to consumers, enabling, in response to a resale permission instruction by the publisher, the first consumer to offer the digital asset for re-sale, as an e-used digital asset, via a plurality of e-tailers, and further registering purchase of the e-used digital asset by either (a) an e-tailer, or (b) a second consumer, or (c) another entity that buys and sells digital assets.

There is additionally provided in accordance with an embodiment of the present invention a system for resale of digital assets, including a registration module that interfaces to a plurality of e-tailers, (i) for registering purchase of a digital asset by a first consumer from any first one of the plurality of e-tailers, for presentation to the first consumer on at least one first device, the digital asset being published by a publisher, wherein each e-tailer sells digital assets published by one or more publishers to consumers, (ii) for enabling, in response to a resale permission instruction from the publisher, the first consumer to offer the digital asset for re-sale, as an e-used digital asset, via each of the plurality of e-tailers, and (iii) for further registering purchase of the digital asset, as an e-used digital asset, by either (a) any one of the plurality of e-tailers, (b) a second consumer, or (c) another entity that buys and sells digital assets.

There is further provided in accordance with an embodiment of the present invention a method for lending of digital assets, including registering purchase of a digital asset by a first consumer via an e-tailer, for presentation to the first consumer on at least one first device, the digital asset being published by a publisher, wherein an e-tailer sells digital assets published by the publisher to consumers, enabling, in response to a lending permission instruction by the publisher, the first consumer to offer the digital asset for loan during a loan period, further registering loan of the digital asset to a second consumer, for presentation to the second consumer on at least one second device during the loan period, preventing the at least one first device from presenting the digital asset for the duration of the loan period, re-enabling the at least one first device to present the digital asset after termination of the loan period, and preventing the at least one second device from presenting the digital asset after termination of the loan period.

There is yet further provided in accordance with an embodiment of the present invention a system for lending of digital assets, including a registration module (i) for registering purchase of a digital asset by a first consumer from an e-tailer, for presentation to the first consumer on at least one first device, the digital asset being published by a publisher, wherein an e-tailer sells digital assets published by one or more publishers to consumers, (ii) for enabling, in response to a lending permission instruction from the publisher, the first consumer to offer the digital asset for loan during a loan period, and (iii) for further registering loan of the digital asset, to presentation to a second consumer on at least one second device during the loan period, and a loan clearing module, coupled with the registration module, (iv) for preventing the at least one first device from presenting the digital asset for the duration of the loan period, (v) for re-enabling the at least one first device to present the digital asset after termination of the loan period, and (vi) for preventing the at least one second device from presenting the digital asset after termination of the loan period.

There is moreover provided in accordance with an embodiment of the present invention a method for determining a market price for a digital asset, including registering one or more offers to sell a digital asset published by a publisher, by respective one or more consumers who have purchased the digital asset through an e-tailer, and who have obtained permission from the publisher to sell the digital asset at a price range specified by the publisher, wherein the e-tailer sells digital assets published by the publisher to consumers, registering one or more offers to buy the digital asset by respective one or more potential buyers, analyzing the one or more registered offers to sell and the one or more registered offers to buy, to determine a price for the digital asset, and allocating at least a portion of the price to the publisher and a portion of the price to the e-tailer.

There is additionally provided in accordance with an embodiment of the present invention a system for determining a market price for a digital asset, including a registration module for registering one or more offers to sell a digital asset published by a publisher, by respective one or more consumers who have purchased the digital asset through an e-tailer, and who have obtained permission from the publisher to sell the digital asset at respective one or more prices, wherein the e-tailer sell digital assets published by the publisher to consumers, and for registering one or more offers to buy the digital asset by respective one or more potential buyers, an analysis module, coupled with the registration module, for analyzing the one or more registered offers to sell and the one or more registered offers to buy, to determine a price for the digital asset, and a revenue allocator, coupled with the analysis module, for allocating at least a portion of the price to the publisher and a portion of the price to the e-tailer.

There is further provided in accordance with an embodiment of the present invention a method for creating a market for a digital asset, including registering one or more offers to sell a digital asset published by a publisher, by respective one or more consumers who own the digital asset and who have obtained permission from the publisher to sell the digital asset at a price range specified by the publisher, registering one or more offers to buy the digital asset by respective one or more potential buyers, registering revenue shares that prescribe portions of sales revenue that are allocated to the publisher, analyzing the one or more registered offers to sell, the one or more registered offers to buy and the registered revenue shares, to determine a buy and sell price, purchasing at the determined buy price copies of the digital asset from the one or more consumers who have registered offers to sell the asset, selling at the determined sell price the purchased assets to the one or more potential buyers who have registered offers to buy the asset, and allocating a portion of the sales revenue to the publisher in accordance with the registered revenue shares.

There is yet further provided in accordance with an embodiment of the present invention a system for creating a market for a digital asset, including a market registrar for (i) registering one or more offers to sell a digital asset published by a publisher, by respective one or more consumers who own the digital asset and who have obtained permission from the publisher to sell the digital asset at a price range specified by the publisher, (ii) registering one or more offers to buy the digital asset by respective one or more potential buyers, and (iii) registering revenue shares that prescribe portions of sales revenue that are allocated to the publisher, a market analyzer for analyzing the one or more registered offers to sell, the one or more registered offers to buy, and the registered revenue shares, to determine a buy and sell price, and a market transaction manager for (i) purchasing at the determined buy price copies of the digital asset from the one or more consumers who have registered offers to sell the asset, (ii) selling at the determined sell price the purchased assets to the one or more potential buyers who have registered offers to buy the asset, and (iii) allocating a portion of the sales revenue to the publisher in accordance with the registered revenue shares.

There is moreover provided in accordance with an embodiment of the present invention a method for appraising an inventory of digital assets, including determining, for each digital asset in an inventory of registered digital assets and registered rights to each digital asset, a cost of purchasing the registered rights to the digital asset from a content source from which the digital asset can be purchased, and deriving an appraisal value of the inventory based on the determined costs.

There is additionally provided in accordance with an embodiment of the present invention a method for insuring an inventory of digital assets, including dynamically maintaining an inventory of registered digital assets and registered rights to each digital asset, receiving an insurance claim for at least one digital asset in the inventory, and for each digital asset in the insurance claim: locating a content source from which the digital asset can be obtained, and obtaining the registered rights to the digital asset from the located content source.

There is further provided in accordance with an embodiment of the present invention a system for appraising an inventory of digital assets, including an inventory appraiser, for determining, for each digital asset in an inventory of registered digital assets and registered rights to each digital asset, a cost of obtaining the registered rights to the digital asset from a content source from which the digital asset can be purchased, and for deriving an appraisal value of the inventory based on the determined costs.

There is yet further provided in accordance with an embodiment of the present invention a system for insuring an inventory of digital assets, including an inventory manager, for dynamically maintaining information about an inventory of registered digital assets and registered rights to each digital asset, an insurance claim processor, coupled with the inventory manager, for receiving an insurance claim for at least one digital asset in the inventory, a content router, for locating, for each digital asset in the insurance claim, a content source from which the digital asset can be obtained, and a transaction manager, coupled with the content router and with the insurance claim processor, for obtaining, for each digital asset in the insurance claim, the registered rights to the digital asset from the content source located by said content router.

The subject specification uses the term “consumer” for someone that can own, share, loan and sell digital assets. However, the term “consumer” is not intended to be limiting, and it is to be understood that the present invention applies to non-consumers, such as corporations and other entities, that can likewise own, share, loan and sell digital assets.

### BRIEF DESCRIPTION OF THE DRAWINGS

The present invention will be more fully understood and appreciated from the following detailed description, taken in conjunction with the drawings in which:

FIG. 1 is a simplified block diagram of eleven components of a content provisioning and revenue disbursement system, in accordance with an embodiment of the present invention;

FIG. 2 is a simplified flowchart of a process for mapping consumer data to a consumer namespace, in accordance with an embodiment of the present invention;

FIG. 3 is a diagram illustrating namespace mapping for a consumer, in accordance with an embodiment of the present invention;

FIG. 4 is a simplified flowchart for a process of mapping content data to a content namespace, in accordance with an embodiment of the present invention;

FIG. 5 is a simplified flowchart of a process of registering devices and content to a consumer, in accordance with an embodiment of the present invention;

FIGS. 6A, 6B and 6C are diagrams illustrating a system that registers consumer content and services for music, video and e-books, respectively, originating from CDs and other physical media, downloaded via the Internet and over the air, downloaded via peer to peer networks, subscribed to via subscription services, and recorded on recorder devices, in accordance with an embodiment of the present invention;

FIGS. 7A, 7B and 7C are diagrams illustrating registries of a household's music, videos and e-books, respectively, in accordance with an embodiment of the present invention;

FIG. 8 is a simplified flowchart for a process of content routing and media playback, in accordance with an embodiment of the present invention;

FIG. 9 is a diagram illustrating music and video content routing from a multitude of content providers to a multitude of player devices, in accordance with an embodiment of the present invention;

FIG. 10 is a simplified flowchart of a process of registering a consumer's inventory, retrieval and display of inventory on a player device, and playback of media on a player device, in accordance with an embodiment of the present invention;

FIG. 11 is a simplified flowchart of a process of validating and enforcing consumer rights to media, in accordance with an embodiment of the present invention;

FIG. 12 is a simplified block diagram of a content provisioning and subscription revenue disbursement system, in accordance with an embodiment of the present invention;

FIG. 13A is a diagram illustrating subscription revenue sharing between content owners, content distributors, service providers and registrants, in accordance with an embodiment of the present invention;

FIG. 13B is an illustration of an accounting report for distributing the share allocated in FIG. 13A to the content owners, among a plurality of content owners, in accordance with an embodiment of the present invention;

FIG. 14 is a summary diagram of vendors in the content purchase and supply chain, integrated within a content licensing service, in accordance with an embodiment of the present invention;

FIG. 15 is a simplified high-level architecture diagram of a three-tier architecture of a digital asset registry, routing and tracking system 1500, in accordance with an embodiment of the present invention;

FIG. 16 is a simplified architecture diagram of a web services layer for the system of FIG. 15, in accordance with an embodiment of the present invention;

FIG. 17 is a simplified architecture diagram of engine and database layers for the system of FIG. 15, in accordance with an embodiment of the present invention;

FIG. 18 is a simplified architecture diagram of a back end node for the system of FIG. 15, in accordance with an embodiment of the present invention;

FIG. 19 is a simplified block diagram of a system for appraising a media inventory, in accordance with an embodiment of the present invention;

FIG. 20 is a simplified block diagram of a system for insuring a media inventory, in accordance with an embodiment of the present invention;

FIG. 21 is a simplified flowchart of a method for appraising a media inventory, in accordance with an embodiment of the present invention;

FIG. 22 is a simplified flowchart of a method for insuring a media inventory, in accordance with an embodiment of the present invention;

FIGS. 23A and 23B are illustrations of release timelines of prior art release models for physical books and e-books;

FIG. 23C is an illustration of a release timeline for e-books, in accordance with an embodiment of the present invention

FIG. 24 is a simplified block diagram of a system for resale of digital assets, in accordance with an embodiment of the present invention;

FIG. 25 is a simplified flowchart of a method for resale of digital assets, in accordance with an embodiment of the present invention;

FIG. 26 is a simplified block diagram of a system for lending of digital assets, in accordance with an embodiment of the present invention;

FIG. 27 is a simplified flowchart of a method for lending digital assets, in accordance with an embodiment of the present invention;

FIGS. 28A and 28B are simplified diagrams of an e-book lending club, in accordance with an embodiment of the present invention;

FIG. 29 is a simplified block diagram of a system for determining a market price for a digital asset, in accordance with an embodiment of the present invention;

FIG. 30 is a simplified flowchart of a method for determining a market price for a digital asset, in accordance with an embodiment of the present invention;

FIG. 31 is a simplified flowchart of a method for creating a market for digital assets, in accordance with an embodiment of the present invention; and

FIG. 32 is a simplified block diagram of a system for creating a market for digital assets, in accordance with an embodiment of the present invention.

The following definitions are employed throughout the specification.

CONTENT/DIGITAL ASSET—digital media including inter alia music, video, e-books, audiobooks, games and software applications.

CONTENT MAPPING—determining for a designated piece of content and for a designated content media format, one or more IDs for uniquely identifying the designated piece of content.

CONTENT ROUTING—determining an appropriate source from which to transmit designated content to a player device.

MEDIA SERVER—a computer server that archives and provisions media.

NAMESPACE—a range of identifiers that are associated uniquely with items, where items may be inter alia media content, player devices, consumers and households.

PLAYER DEVICE—a media player including inter alia home entertainment systems, mobile phones, portable media players, software applications such as PC applications, and automobile decks.

REGISTRY—a central data store where users' inventories are listed.

TRACKING SERVER—a computer server that tracks content-related events, including inter alia playbacks and purchases.

### DETAILED DESCRIPTION

Embodiments of the present invention provide methods and systems for registration, tracking, rights management, sale, resale, lending and appraisal of digital assets.

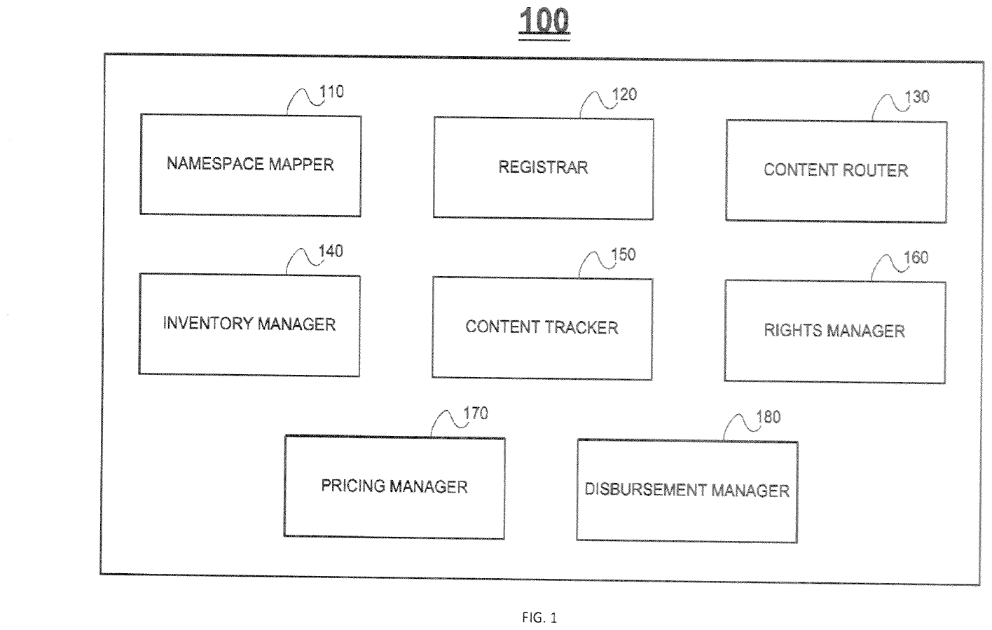

Reference is made to FIG. 1, which is a simplified block diagram of the components of a content management, tracking and revenue disbursement system 100, in accordance with an embodiment of the present invention. The components shown in FIG. 1 are generally implemented in one or more server computers. Operation of each component is described in detail hereinbelow. For ease of reference, the following table summarizes the Figures and the components of FIG. 1 that they relate to.

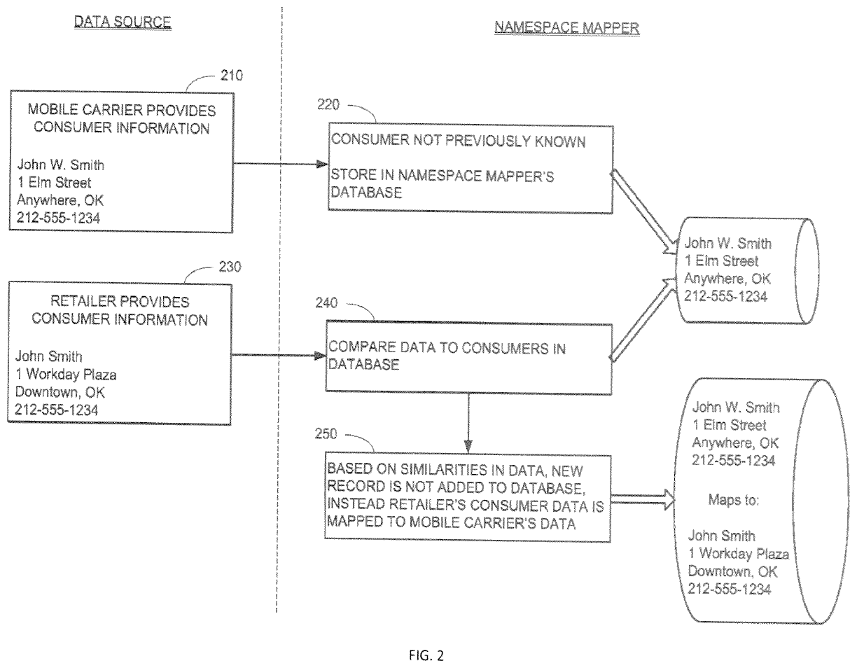

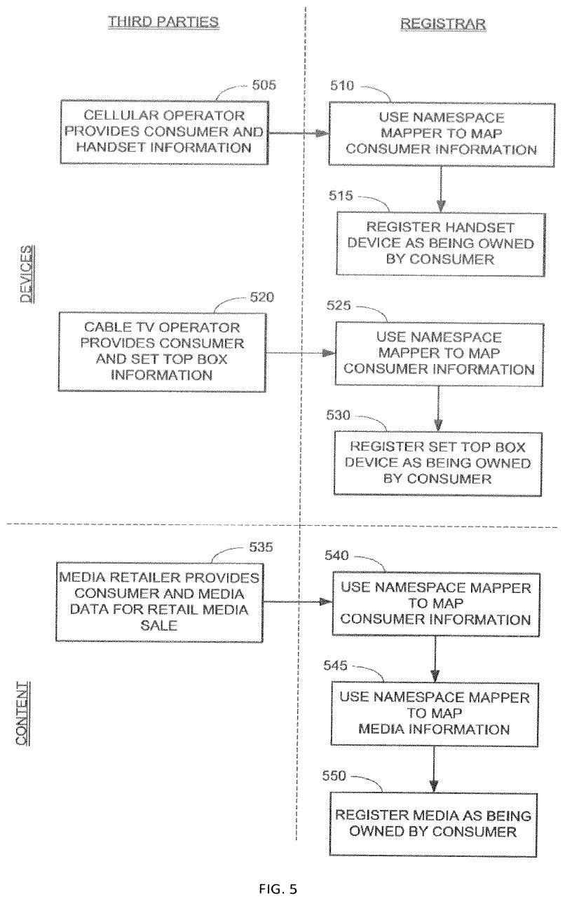

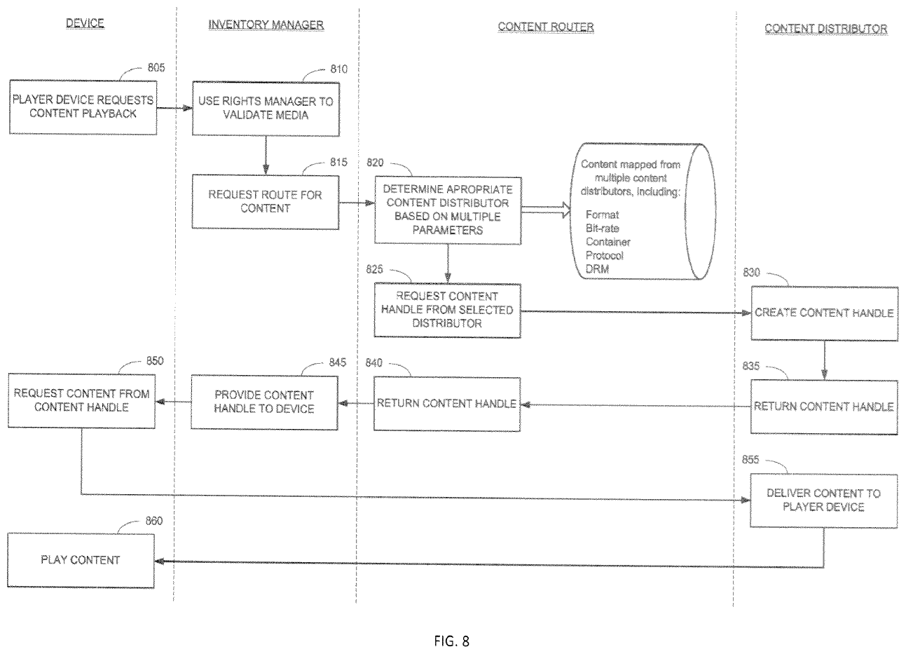

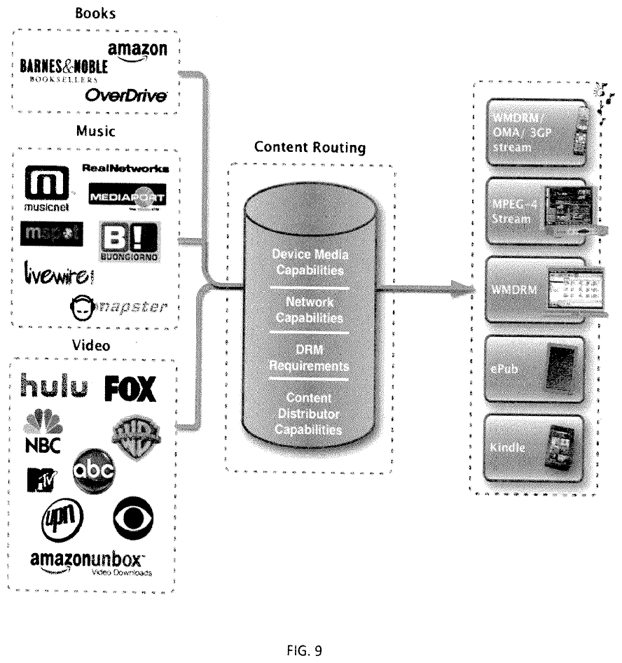

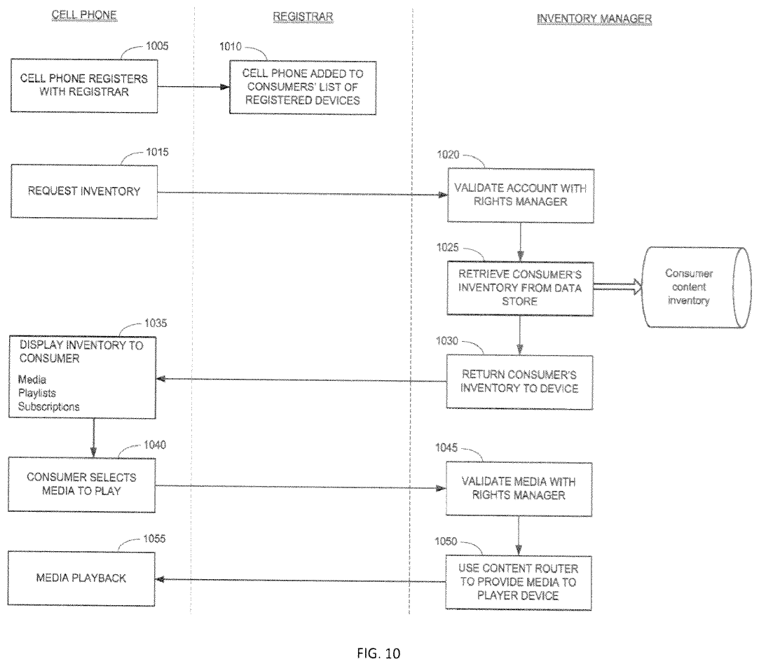

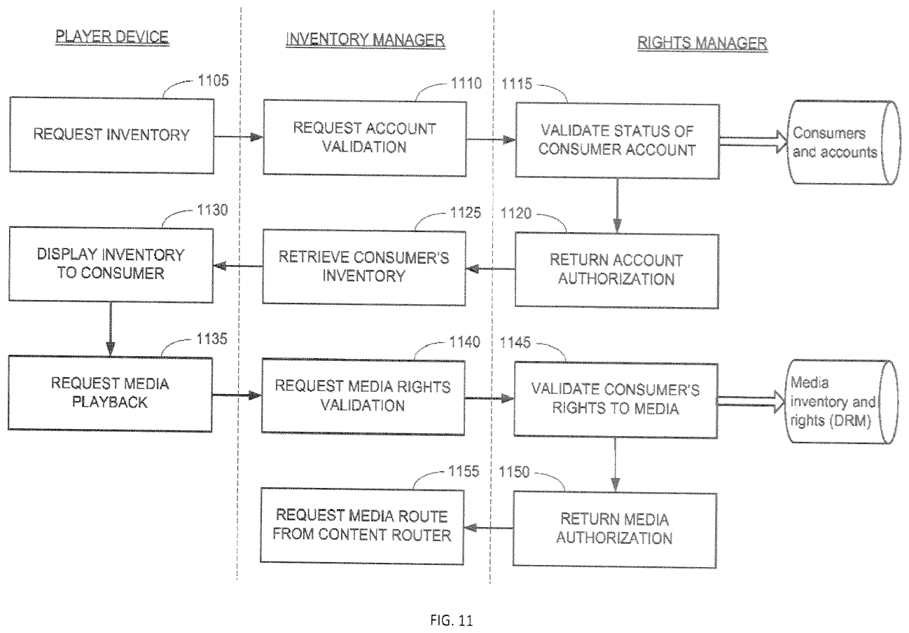

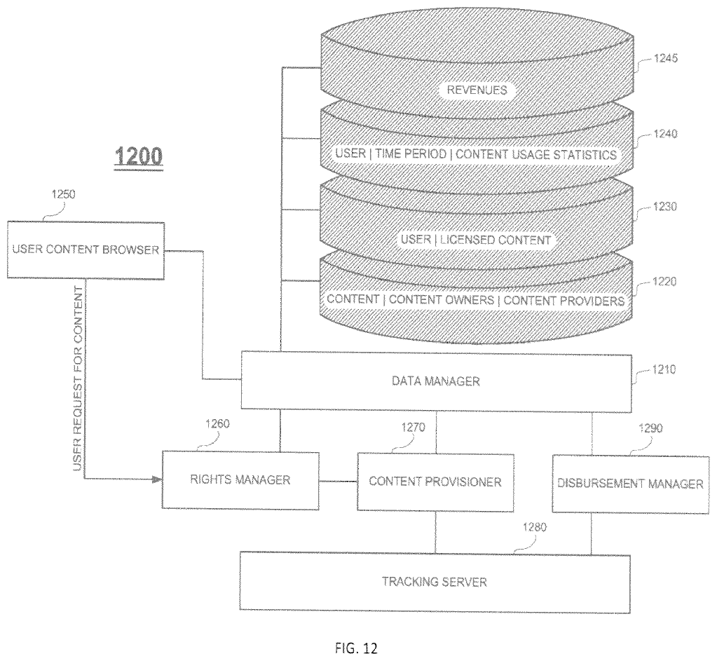

TABLE I
Summary of Figures and components that they relate to

| Component | Figures(s) |
|---|---|
| Namespace Mapper 110 | FIGS. 2-4 |
| Registrar 120 | FIGS. 5-7 |
| Content Router 130 | FIGS. 8 and 9 |
| Inventory Manager 140 | FIG. 10 |
| Rights Manager 160 | FIG. 11 |
| Disbursement Manager 180 | FIGS. 12-14 |

### Namespace Mapper 110

Shown in FIG. 1 is a namespace mapper 110. A “namespace” is a range of identifiers that are associated uniquely with items, where items may be inter alia digital assets, player devices, consumers and households. In general, data obtained from multiple sources may not adhere to the same naming convention, and may further be inconsistent. “Namespace mapping” determines, for a designated item, one or more IDs for uniquely identifying the designated item.

In accordance with embodiments of the present invention, namespace mapper 110 aggregates information from multiple data sources, including inter alia information about media content, information about player devices, information about consumers, and information about companies and other stakeholders in the content purchase and supply chains. In order to disambiguate the information obtained from the multiple sources, namespace mapper 110 uniquely identifies data elements from the multiple sources, and associates them correctly within a centralized registry.

Namespace mapper 110 normalizes content data by mapping content to a reference data store of content. Thus content received from multiple sources with different and possibly incorrect metadata is assigned consistent and correct metadata.

Namespace mapper 110 performs namespace mapping in order to compare information obtained from two or more sources, and determine whether or not the information refers to the same entity. For example, a consumer, John W. Smith, may be identified by attributes including inter alia his name, address and cell phone number in a mobile carrier database. John purchases a CD from Best Buy, and because he is a member of Best Buy's rewards program, his purchase information is recorded in Best Buy's database. However, in the Best Buy database, John's name is listed as “John Smith”, without the middle initial, and his address is different than the address in the mobile carrier database. As such, when the consumer attributes provided by the two data sources are compared, namespace mapper 110 finds that:
Name—the names do not exactly match: John W. Smith vs. John Smith;
Address—the addresses do not match; and
Cell Phone Number—the phone numbers match.

Namespace mapper 110 assigns weights to each attribute (Name, Address, Cell Phone Number), and combines the degrees of match according to the weights in order to determine whether or not the two sets of attributes correspond to the same person. Since a cell phone number is generally unique to an individual, this attribute is assigned a high weight; and since an address may not be unique to an individual, this attribute is assigned a lower weight. As such, based on the similarity of the two names, on the discrepant addresses, and on the identical cell phone numbers, namespace mapper 110 concludes that the two sets of attributes do in fact correspond to the same person. Thus the CD purchased by John at Best Buy is registered with John W. Smith's acquired content, as described hereinbelow.

Reference is made to FIG. 2, which is a simplified flowchart of a process for mapping consumer data to a consumer namespace, as performed by namespace mapper 110, in accordance with an embodiment of the present invention. The flowchart of FIG. 2 is divided into two columns. The left column indicates steps performed by a data source, and the right column indicates steps performed by a namespace mapper, such as namespace mapper 110.

At step 210 a mobile carrier provides consumer information to system 100. The example shown in FIG. 2 relates to the above John Smith example. The carrier's information includes the name spelled as “John W. Smith”, the address “1 Elm Street, Anywhere, OK”, and the phone number “212-555-1234”. At step 220 the namespace mapper checks if this customer is already known to system 100. If not, then the namespace mapper stores the customer data as a new customer record in a data store.

At step 230 a retailer, such as Best Buy, provides consumer information to system 100. The consumer information differs from the information provided by the mobile carrier at step 210 in the spelling of the consumer's name, and in the address. At step 240 the namespace mapper checks if this customer is already known to system 100 and compares the consumer information to information stored in the data store. At step 250, based on similarities in name and telephone number as indicated above, the namespace mapper concludes that the retailer's customer information corresponds to the mobile carrier's customer information. As such, the namespace mapper does not add a new customer record to the data store, but instead maps the retailer's customer information to the already existing record with the mobile carrier's customer information.

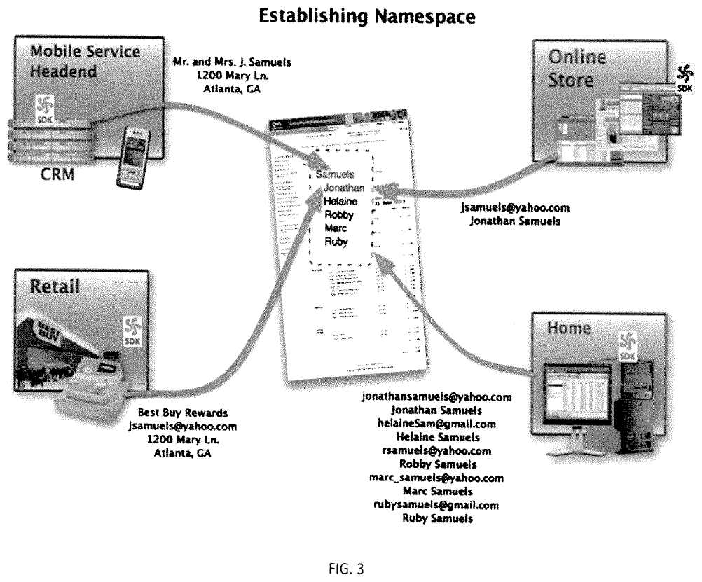

Reference is made to FIG. 3, which is a diagram illustrating namespace mapping for a consumer, in accordance with an embodiment of the present invention. Shown in FIG. 3 is information about a consumer, Jonathan Samuels, arriving from four sources of information; namely, a mobile carrier database, a Best Buy rewards program database, an online store database, and a consumer home computer file directory. The mobile carrier database provides identifying information about Jonathan Samuels, such as his name, address and cell phone number. The Best Buy database provides identifying information about content that Jonathan Samuels purchases at a Best Buy retail store. The online store database provides information about content that Jonathan Samuels purchases online. The home computer file directory provides information about content that Jonathan Samuels has stored on his home computer. In accordance with an embodiment of the present invention, the four sources are integrated in order to register all of Jonathan Samuels' content.

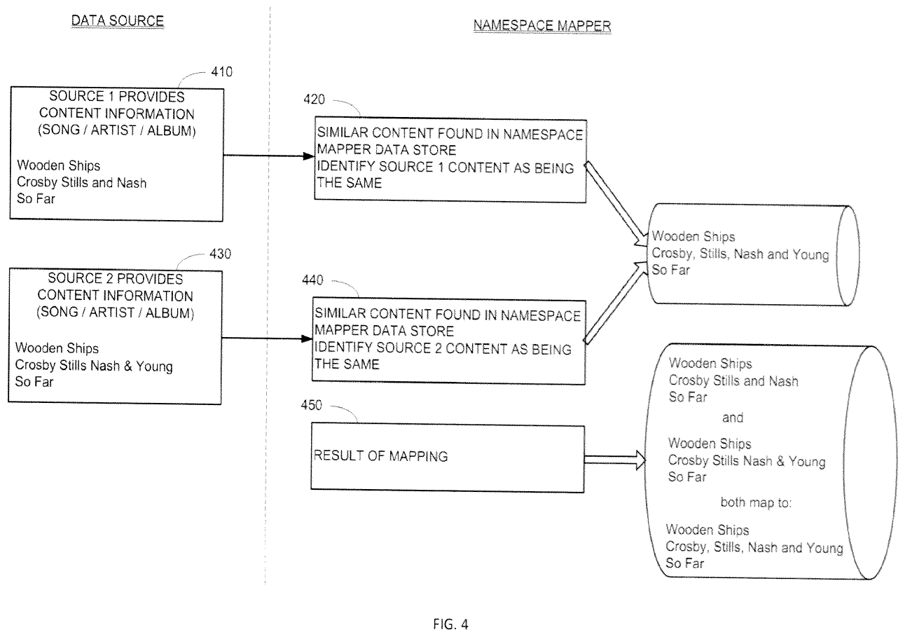

Reference is made to FIG. 4, which is a simplified flowchart for a process of mapping content data to a content namespace, as performed by namespace mapper 110, in accordance with an embodiment of the present invention. The flowchart of FIG. 4 is divided into two columns. The left column indicates steps performed by a data source, and the right column indicates steps performed by a namespace mapper, such as namespace mapper 110.

At step 410 a first data source, for example, a metadata aggregator, provides information about media content. In the example shown in FIG. 4, the information includes a song “Wooden Ships”, an artist “Crosby Stills and Nash”, and an album “So Far”. At step 420 the namespace mapper checks if the media information is already stored in a data store. For the case at hand, the data store has an already existing record with a song “Wooden Ships”, an artist “Crosby, Stills, Nash and Young”, and an album “So Far”. Based on similarities in the information, the namespace mapper concludes that the content matches similar content found in the data store, and identifies the content information received from the metadata aggregator as corresponding to the already existing record in the data store.

Similarly, at step 430 a second data source, for example, the on-line Napster® content source, provides information about media content. The information differs from the information provided by the metadata aggregator at step 410 in that the artist name is “Crosby Stills Nash & Young”, and differs from the already existing record in the data store in that the artist is punctuated “Crosby, Stills, Nash and Young”. At step 440 the namespace mapper concludes that the content matches the similar content found in the data store, and identifies the content information received from Napster as corresponding to the already existing record in the data store. At step 450 the namespace mapper has mapped both the content information received from the metadata aggregator and the content information received from Napster to the same already existing record in the data store.

In one embodiment of the present invention, the namespace mapper receives uniquely identifying data from data providers, and the mapping process is trivial. In one embodiment of the present invention, the namespace mapper receives e-book information from publishers, where the e-book is identified by a globally unique identifier, such as an ISBN.

### Registrar 120

Shown in FIG. 1 is a registrar 120, which registers a consumer's digital assets, content services, and devices with a central data store. For each asset registered, registrar 120 generates an asset status, including inter alia digital rights management data for the asset.

Registrar 120 registers, to the consumer, media that was communicated to registrar 120 by a third party such as inter alia a media store. Additionally, registrar 120 registers, to a consumer, media subscriptions and media services purchased from a third party such as inter alia a content subscription service. Additionally, registrar 120 registers player devices owned by the consumer.

Reference is made to FIG. 5, which is a simplified flowchart of a process of registering devices and content to a consumer, as performed by registrar 120, in accordance with an embodiment of the present invention. The flowchart of FIG. 5 is divided into two columns. The left column indicates steps performed by third parties, and the right column indicates steps performed by a registrar, such as registrar 120. Moreover, steps 505-530 relate to registration of consumer devices, and steps 535-550 relate to registration of consumer content.

At step 505 a cellular operator provides information about a consumer and his handset. At step 510 the registrar invokes namespace mapper 110 to map the consumer information to its data store, as described hereinabove with reference to FIG. 3. At step 515 the registrar registers the handset device as being owned by the consumer.

At step 520 a cable TV operator provides information about a consumer and his set top box. At step 525 the registrar invokes namespace mapper 110 to map the consumer information to its data store, as described hereinabove with reference to FIG. 2. At step 530 the registrar registers the set top box device as being owned by the consumer.

At step 535 a media retailer sends consumer and media data for a retail media sale, to the registrar. At step 540 the registrar invokes namespace mapper 110 to map the consumer information to its data store, as described hereinabove with reference to FIG. 2. At step 545 the registrar invokes namespace mapper 110 to map the media data to its data store, as described hereinabove with reference to FIG. 4. At step 550 the registrar registers the media as being owned by the consumer.

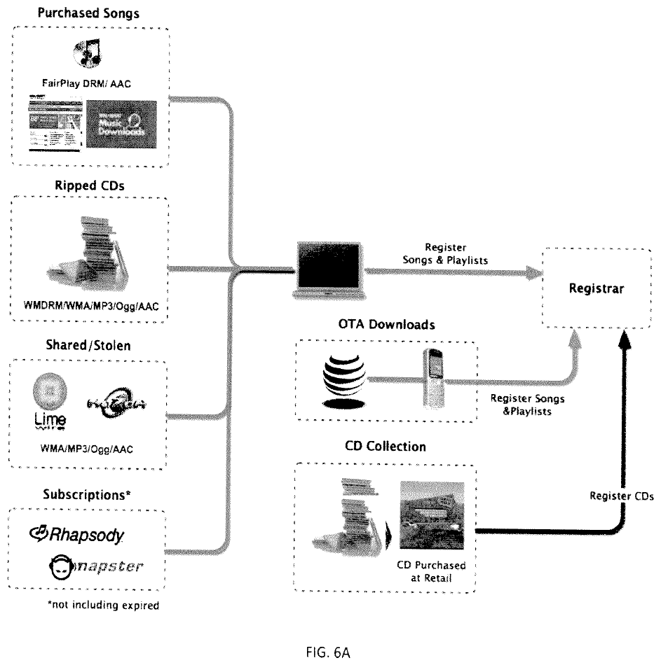

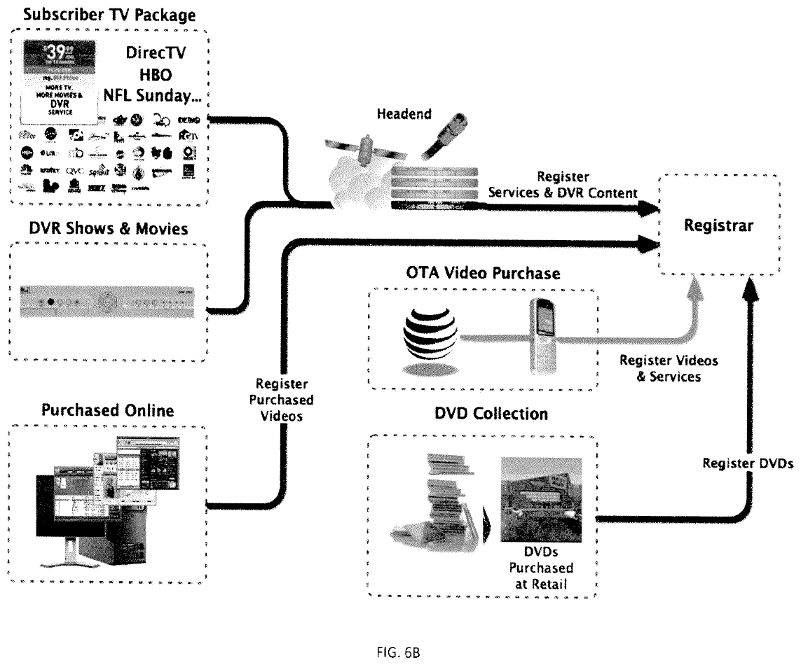

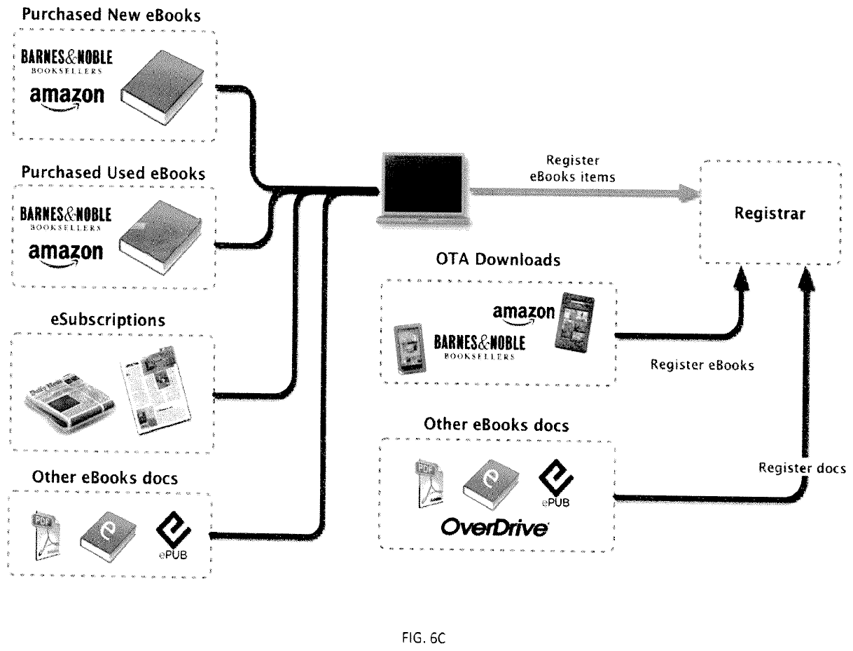

Reference is made to FIGS. 6A, 6B and 6C, which are diagrams illustrating a system that registers consumer content and services for music, video and e-books, respectively, originating from CDs and other physical media, downloaded via the Internet and over the air, downloaded via peer to peer networks, subscribed to via subscription services, and recorded on recorder devices, in accordance with an embodiment of the present invention.

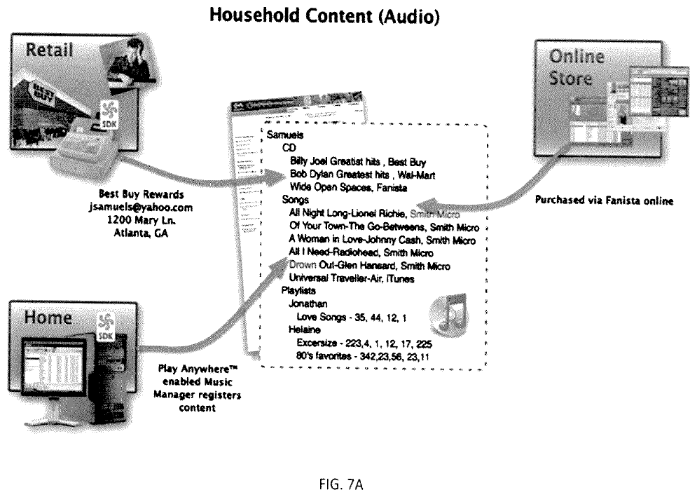

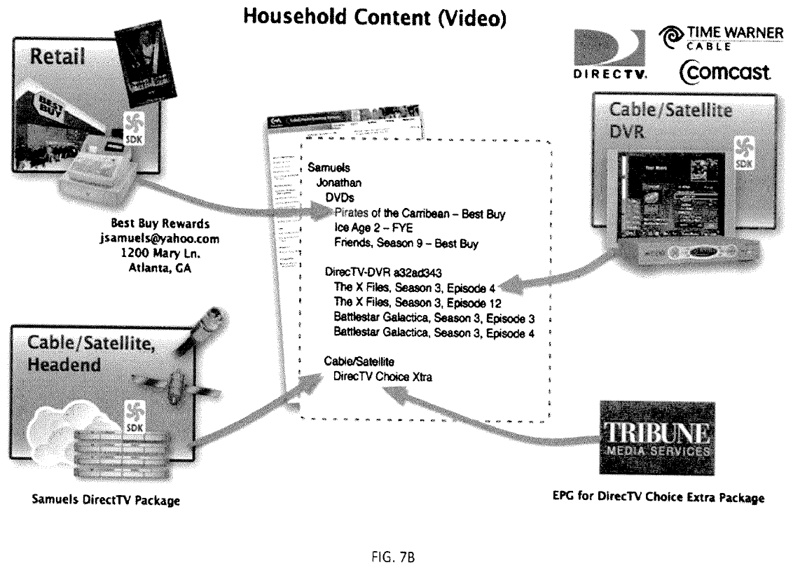

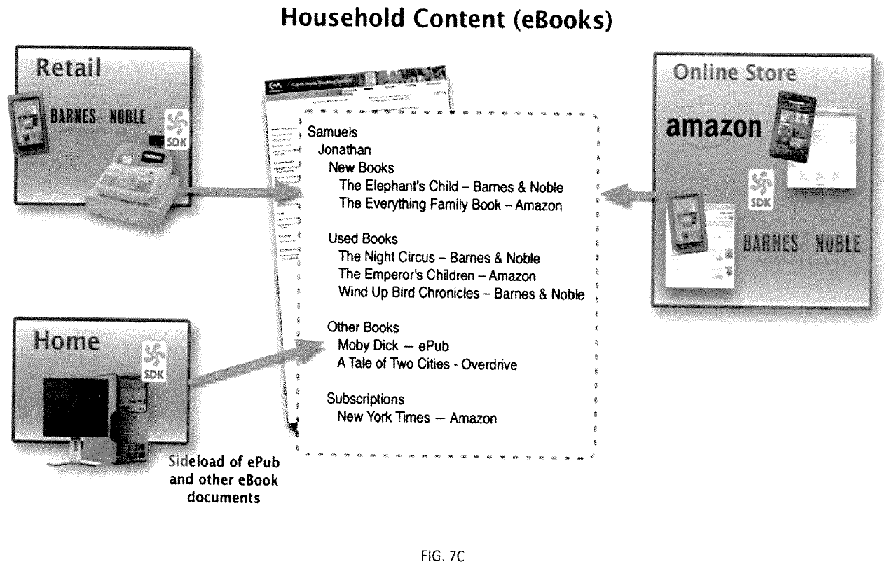

A consumer may register his entire household, which includes multiple consumer names, cell phone IDs, PC IDs, e-book reader IDs, and other player device IDs. Reference is made to FIGS. 7A, 7B and 7C, which are diagrams illustrating registries of a household's music, videos and e-books, respectively, in accordance with an embodiment of the present invention. For music, FIG. 7A shows registration of the Samuels' songs, CDs and playlists into a registry for the Samuels household. For video, FIG. 7B shows registration of the Samuels' DVDs, DirecTV digital video recordings (DVRs), and cable and satellite subscriptions into the registry for their household. For e-books, FIG. 7C shows registration of the Samuels' e-books purchased from a variety of e-book retailers.

As described herein, entities registering consumers, content and other data may themselves be registries of such data. As such, embodiments of the present invention provide a “registry of registries”. It will be appreciated by those skilled in the art that the capacity to act as a registry of registries enables monetization opportunities among various entities that maintain disparate registries, and who would not otherwise have such opportunities.

### Content Router 130

Shown in FIG. 1 is a content router 130. “Content routing” refers to determining an appropriate source from which to transmit designated content to a player device. Content router 130 maintains a data store of sources of content and of information regarding the content provided by the sources, including inter alia (i) media metadata, which may have previously been mapped into a standard namespace using namespace mapper 110, (ii) delivery bit-rate(s) that the content source is capable of providing, (iii) media format(s) or codec(s) that the content source is capable of providing, (iv) media container formats that the content source is capable of providing, (v) DRM types that the content source is capable of providing, and (vi) geographical regions that the content source serves.

When playback or delivery of media is requested, content router 130 dynamically evaluates the data in its data store vis-à-vis the playback or delivery requirement, and vis-à-vis capabilities of the playback device, and selects the most appropriate source of content for this particular instance.

In an embodiment of the present invention, playback of media is performed from a copy of the content stored locally on the player device. Such local copy may have been stored on the player device by the user independently of the present invention, or may have been cached on the player device during an earlier playback from a source of content identified by counter router 130.

Reference is made to FIG. 8, which is a simplified flowchart for a process of content routing and media playback, as performed by content router 130, in accordance with an embodiment of the present invention. The flowchart of FIG. 8 includes four columns. The leftmost column indicates steps performed by a consumer device, such as a media player; the second-from-left column indicates steps performed by an inventory manager, such as inventory manager 140; the second-from-right column indicates steps performed by a content router, such as content router 130; and the rightmost column indicates steps performed by a content distributor.

At step 805 the device requests media content for playback. At step 810 the inventory manager invokes a rights manager, such as rights manager 160, to validate the request. If the rights manager validates the request, then at step 815 the inventory manager requests the content router to provide a content route for obtaining the requested content. At step 820 the content router determines an appropriate content distributor, for providing the requested content to the requesting device, based on multiple parameters including inter alia content format, transmission bit-rate, content container, transmission protocol and content digital rights management (DRM).

At step 825 the content router requests a handle to the requested content from the appropriate distributor as determined at step 820. At step 830 the content distributor generates the content handle, and at step 835 the content distributor returns the content handle to the content router. In turn, at step 840 the content router forwards the content handle to the inventory manager and, at step 845, the inventory manager provides the content handle to the device.

At step 850 the device uses the content handle to request content from the content distributor. At step 855 the content distributor delivers the content to the device. Finally, at step 860 the device receives the content, originally requested at step 805, from the content distributor, and plays the received content.

Reference is made to FIG. 9, which is a diagram illustrating music, video and video e-book routing from a multitude of content providers to a multitude of player devices, in accordance with an embodiment of the present invention. As shown in FIG. 9, different player devices may require different content formats, and may require different digital rights management technologies.

### Inventory Manager 140

Shown in FIG. 1 is an inventory manager 140, which maintains information regarding consumers' media inventories, including inter alia music, videos, playlists, e-books, podcasts and content subscriptions. Inventory manager 140 provides a consumer's inventory to the consumer's player devices, when requested by the consumer.

Reference is made to FIG. 10, which is a simplified flowchart of a process of registering a consumer's inventory, retrieval and display of inventory on a player device, and playback of media on a player device, as performed by inventory manager 140, in accordance with an embodiment of the present invention. The flowchart of FIG. 10 is divided into three columns. The left column indicates steps performed by an exemplary consumer device such as a cell phone, the middle column indicates steps performed by a registrar, such as registrar 120, and the right column indicates steps performed by an inventory manager, such as inventory manager 140.

At steps 1005 and 1010 the cell phone is registered with the registrar, as described hereinabove with reference to FIG. 5.

At step 1015 the cell phone requests from the inventory manager an inventory summary of media registered to the consumer. At step 1020 the inventory manager invokes a rights manager, such as rights manager 160, to validate the consumer's account. If the rights manager validates the consumer's account, then at step 1025 the inventory manager retrieves the consumer's inventory summary information from the data store. At step 1030 the inventory manager returns the user's inventory summary information to the cell phone.

At step 1035 the cell phone displays the inventory summary information to the consumer. At step 1040 the consumer selects media to be played, from the media listed in the inventory summary information. At step 1045 the inventory manager invokes the rights manager to validate the consumer's rights to the selected media. If the rights manager validates the media, then at step 1050 the inventory manager invokes the content router to provide the media to the player device, as described hereinabove with reference to FIG. 8. Finally, at step 1055 the cell phone plays the media that was requested at step 1040.

Consumer media inventory may be cached on a player device, obviating the need for inventory manager 140 to provide it at every instance. When the inventory is cached on a player device, inventory manager 140 maintains versioning information regarding the cached inventory and the current state of the consumer's inventory. This allows inventory manager to provide an updated view of the consumer's inventory to the player device so that the player device can update its cached inventory.

### Content Tracker 150

Shown in FIG. 1 is a content tracker 150, which tracks acquisition, playback and display of digital assets by a consumer, and changes in ownership of assets.

Content tracker 150 maintains, in a data store, an acquisition log that tracks asset acquisition events for consumers. Data stored in the acquisition log includes inter alia the identity of a consumer, the identity of an asset, the identity of a content store or other service which provided the asset, and the date and time of the acquisition. The acquired asset may be owned by the acquiring consumer, or may have been shared with the consumer by another consumer, or may have been loaned to the consumer by another consumer.

Additionally, content tracker 150 maintains, in the data store, a playback log that tracks content playback events for consumers. Data stored in the playback log includes inter alia the identity of the consumer, the identity of the content, the identity of the device on which the content was played, the length of time the content was played, and the date and time of the playback.

Additionally, content tracker 150 maintains, in the data store, a sharing log that tracks shares of digital assets from consumer to consumer. Data stored in the sharing log includes inter alia the identity of a sharing consumer, the identity of a consumer receiving the share, and the identity of a digital asset being shared.

Additionally, content tracker 150 maintains, in the data store, a lending log that tracks loans of digital assets from consumer to consumer. Data stored in the lending log includes inter alia the identity of a lending consumer, the identity of a consumer receiving the loan, and the identity of a digital asset being loaned.

In accordance with an embodiment of the present invention, content tracker 150 tracks lending of content and tracks when a loaned content item is subsequently purchased.

Content tracker 150 also associated loans with subsequent purchases, in cases where there are multiple loans of a content item culminating in a purchase. E.g., if consumer A lends a content item to consumer B, and consumer B lends the same content item to consumer C, and consumer C subsequently purchases the item, then content tracker 150 associates consumer C's purchase with consumer A's original loan.

Additionally, content tracker 150 maintains, in the data store, a resale log that tracks resales of digital assets from consumer to consumer. Data stored in the log includes inter alia the identity of a selling consumer, the identity of a buying consumer or other purchasing entity, the identity of an e-tailer that facilitated the sale, if any, and the identity of a digital asset being sold.

In accordance with an embodiment of the present invention, content tracker 150 tracks sharing of content and tracks when a shared content item is subsequently purchased.

A consumer may request from system 100 that a content item registered to him be shared with another consumer. Registrar 120 registers the content to the recipient and indicates that the recipient has a trial license for the content. Content tracker 150 records the share in its sharing log.

When the recipient's trial license for the content expires, the recipient may be offered to purchase the content. Such purchase, if effectuated, then causes registrar 120 to register the content as being owned by the recipient, and causes content tracker 150 to record the purchase event, and to associate the share with the subsequent purchase.

Content tracker 150 also associates shares with subsequent purchases in a case where there are multiple shares of a content item culminating in a purchase. For example, if consumer A shares a content item with consumer B, and consumer B shares the same content item with consumer C, and consumer C subsequently purchases the item, then contact tracker 150 associates customer C's purchase with consumer A's original share.

It will be appreciated by those skilled in the art that content tracker 150 facilitates super-distribution of content.

The present invention has application to usage tracking for purposes of revenue sharing or for purposes of logging usage history. The present invention is advantageous for tracking the following information for content:
(a) if recorded, when it was recorded and from which provider;
(b) if purchased directly, the fulfiller of the purchase;
(c) if purchased, other content, if any, that is associated with the purchased content and may have contributed to the consumer's decision to make the purchase;
(d) if shared, the consumer who originally owned the copy, the original fulfiller, and the sharing chain of consumers;
(e) if loaned, the consumer who loaned the copy, the original fulfiller, and the loaning chain of consumers;
(f) play information for the current owner, whether played on the owner's recorder device or on the owner's player device or on other devices; and
(g) if upgraded from a trial version, the fulfiller of the original purchase by the original owner and the fulfiller of the purchase from the trial version.

### Rights Manager 160

Shown in FIG. 1 is a rights manager 160, which enforces digital rights management.

Rights manager 160 maintains a data store of consumer accounts. When a consumer attempts to access system 100, rights manager 160 consults the data store to validate whether or not the consumer's account has the right to access the system, and grants or denies access accordingly.

Additionally, rights manager 160 utilizes a data store of consumers' rights to access given digital assets.

Rights manager 160 may grant full access for a consumer to a given content item, may deny access, and may provide limited access. Limited access includes inter alia the right to access content for a specific time period, during a specific date range, for a limited number of plays, or in specific geographical locations. Limited access may be used to support trial content.

When a user requests to play or display a designated piece of content on a designated player device, the request is transmitted to rights manager 160, which confirms that the user has a currently valid license to the requested content. If the user does not have a currently valid license to the requested content, the play request is denied. In one embodiment of the present invention, if the user had a limited license for the requested content which is no longer valid, system 100 enables the user to purchase a valid license.

Rights manager 160 may obtain information regarding a consumer's rights to a designated item of content from a third party such as inter alia a media store or a media subscription service. When a consumer purchases content or a content subscription from a store, the store may transmit to registrar 120 information about the consumer, the purchase, and the usage rules applicable to the designated user and the designated content. Registrar 120 stores the results in a data store where they are enforced by rights manager 160.

Reference is made to FIG. 11, which is a simplified flowchart of a process of validating and enforcing consumer rights to media, as performed by rights manager 160, in accordance with an embodiment of the present invention. The flowchart of FIG. 11 is divided into three columns. The left column indicates steps performed by a consumer's player device; the middle column indicates steps performed by an inventory manager, such as inventory manger 140; and the right column indicates steps performed by a rights manager, such as rights manager 160.

At step 1105 the player device requests a summary of its inventory from the inventory manager. At step 1110 the inventory manager requests the rights manager to validate the consumer's account. At step 1115 the rights manager validates the status of the consumer's account by consulting a consumer account data store. If the consumer's account is valid, then at step 1120 the rights manager returns an account authorization to the inventory manager. At step 1125 the inventory manager retrieves the consumer's inventory information, as described hereinabove with reference to FIG. 10, and sends it to the player device.

At step 1130 the player device displays to the consumer his summary inventory information. At step 1135 the player device requests, from the inventory manager, media from the inventory for playback. At step 1140 the inventory manager requests the rights manager to validate the consumer's rights to the requested media. At step 1145 the rights manager validates the consumer's rights by consulting a media inventory and rights data store. If the rights manager validates the consumer's rights to the requested media, then at step 1150 the rights manager returns a media authorization to the inventory manager. At step 1155 the inventory manager requests a route to the media from content router 130, as described hereinabove with reference to FIG. 8.

Additionally, rights manager 160 uses a data store of consumers' rights to resell digital assets that are registered to them.

Rights manager 160 may obtain information regarding the right to resell assets inter alia from the publisher of the assets, or from the e-tailer who sold the assets to the consumer.

Resell rights may be granted or revoked for (i) a specific digital asset, such as a specific e-book title, (ii) a specific instance of a digital asset, such as a specific copy of a specific e-book title owned by a specific consumer, or (iii) a class of assets, such as a set of e-books rather than one particular e-book.

Re-sell rights may be controlled by a number of factors, including inter alia (i) the length of time that has passed since the original release of a digital asset, (ii) the number of copies of the asset that have been sold, (iii) the number of copies of the asset that have been made available for sale by consumers, (iv) the cumulative revenue generated by sales of the asset, (v) the number of copies of the asset that have been re-sold, (vi) for a specific copy of a digital asset, the length of time that has passed since the first resale of that asset, (vii) for a specific copy of an asset, the length of time the consumer has owned the asset, (viii) for a specific copy of an asset, the number of times the asset has been re-sold, (ix) the sale price or buy price of a particular asset as may be provided, for example, by pricing manager 170, or any combination of (i)-(ix) above.

Any of the resale rights described herein may be provided to rights manger 160 as rules which rights manager 160 invokes, based on trigger events described in the rules. E.g., a publisher of an e-book notifies rights manager 160 that a particular e-book title will become available for resale on a particular date, and will remain available for resale until ten thousand resale events occur.

Alternatively, the resale rights may be provided to rights manager 160 as absolute rights. E.g., a publisher of an e-book notifies rights manager 160 that a particular e-book is available for resale as of the time of the notification, with no additional rules.

For a resale right that is based on the number of times a specific copy of an asset has been re-sold, rights manager 160 may be instructed to increase a resale counter for some sales, and to not increase the resale counter for other sales. E.g., a sale of an e-used asset from a first consumer to a second consumer increases the resale counter, whereas a sale of an e-used asset from a consumer to a retailer does not increase the resale counter.

Additionally, rights manager 160 uses a data store of consumers' rights to lend digital assets to other consumers. In an embodiment of the present invention, the publisher of a digital asset or the retailer of a digital asset allows consumers who purchased the asset to lend it under certain conditions to other consumers.

Lending rights may be granted or revoked for (i) a specific digital asset, such as a specific e-book title, (ii) a specific instance of a digital asset, such as a specific copy of a specific e-book title owned by a specific consumer, or (iii) a class of assets, such as a set of e-books rather than one particular e-book.

Lending rights may be controlled by a number of factors including inter alia the factors described hereinabove with reference to resale rights.

Additionally, such lending rights may be limited by a number of factors, including inter alia (i) the number of copies of the asset that may be loaned simultaneously by single consumer, and (ii) the maximum time for a single loan event. E.g., a publisher of a digital asset may specify that a consumer who has purchased the digital asset may loan one copy of the asset to one second consumer for a period of no more than two weeks.

A lending right for an asset maintained by rights manager 160 may be a generic right to lend the asset to any other consumer, or may be a right to lend the asset to a limited set of consumers.

### Pricing Manager 170

Shown in FIG. 1 is a pricing manager 170, which determines buy and sell prices for e-used digital assets, based on externally supplied constraints and based on dynamic calculations.

Pricing manager 170 receives input, inter alia from publishers and retailers, regarding prices or price constraints. In addition, pricing manager 170 receives, from consumers, offers to sell digital assets and offers to buy digital assets, where each buy and sell offer is associated with a specific buy or sell price. Such buy and sell offers may be registered with pricing manger 170 directly by consumers, or may be registered by retailers or by other entities that aggregate buy and sell offers.

Pricing manager 170 evaluates such buy and sell offers, as may be provided by consumers or other entities, and uses them to establish reasonable buy and sell prices for the assets made available for sale. The buy and sell prices may be established so as to ensure that as many sell offers as possible may be filled by matching buy offers. Alternatively, the buy and sell prices may be established so as to maximize the price spread between sell prices and buy prices.

Externally supplied constraints may be fixed buy prices and sell prices, or they may be prices that change each time an asset is sold. E.g., the second tier resale and purchase prices for a particular asset may be determined by the publisher to be $5 and $10, respectively. The original owner of the asset receives $5 for the sale of the asset to a second consumer, and the second consumer pays $10 for the asset. Further, the third tier resale and purchase prices may be determined to be $2 and $5, respectively. The consumer who purchased the asset in the second tier for $10 may resell the asset, and receive $2 for the sale, and the purchasing consumer pays $5 for the asset.

It will thus be appreciated by those skilled in the art that the present invention facilitates a price spread, thus providing a source of revenue that is distributed by disbursement manager 180 as explained hereinbelow.

### Disbursement Manager 180

Shown in FIG. 1 is a disbursement manager 180, which allocates revenue to various stakeholders in the content purchase and supply chains.

Reference is made to FIG. 12, which is a simplified block diagram of a revenue disbursement system 1200, in accordance with an embodiment of the present invention. Shown in FIG. 12 is a data manager 1210, which manages four data stores. The first data store, 1220, stores records of content, content owners, and content providers. The second data store, 1230, stores records of users and their acquired content. The third data store, 1240, stores a content usage history log, including display, playback, sales and loans, according to user and time period. The fourth data store, 1245, stores records of revenues generated from various sources, including inter alia (i) from media purchase, (ii) from media subscriptions, (iii) from media access services, and (iv) from advertising.

Also shown in FIG. 12 is a user content browser 1250, such as a player device, which enables a user to interactively browse, organize and access his content and his playlists.

Also shown in FIG. 12 is a rights manager 1260, such as rights manager 160. If rights manager 1260 verifies that the user has a currently valid license to the requested content, then a content provisioner 1270, such as content router 130, identifies one or more sources that can supply the requested content to the user in a format compatible with the user's player device.

A tracking server 1280, such as content tracker 150, records a history log regarding the user's plays, sales, purchase and loans of content, and a disbursement manager 1290, such as disbursement manager 180, uses the history log to disburse subscription revenue received from the user to content owners and content provisioners, and other stakeholders in the purchase and delivery chains.

It will be appreciated by those skilled in the art that embodiments of the present invention enable revenue disbursement among various partners in content purchase and supply chains, including inter alia (i) content owners, (ii) service providers, (iii) content distributors, (iv) registrants, (v) enablers, (vi) consumers, and (vii) other vendors that enable operation of embodiments of the present invention.

Content owners are entities that hold intellectual property rights to content. These rights include inter alia publishing rights, rights to sound recordings, rights to video recordings and distribution rights. Content owners may be inter alia music labels, music publishers, e-book publishers, collecting societies, movie studios and movie production companies.

Service providers are companies that provide services directly to consumers. Service providers generally maintain customer relationships, and are responsible for billing and collection.

Content distributors are generally responsible for aggregating acquired content and delivering the content to consumers' devices. Delivery is via download or streaming, over the Internet or other communication channels. In some instances, a mobile operator may provide its own content, in which case the mobile operator serves as both an operator and a content manager. In other instances, content may reside with a plurality of content managers. Embodiments of the present invention support integration and revenue disbursement in all instances.

Registrants are generally responsible for registering consumer ownership of media with registrar 120. Registrants may be inter alia media retail stores. When a store sells a media item to a consumer, the store notifies registrar 120 of the sale, and registrar 120 maintains a record indicating that the media retailer is the registrant for the subject media and for the subject customer. Disbursement manager 180 utilizes this information for allocating revenue to appropriate members of the content supply chain.

Enablers are generally responsible for causing a device or software application to be compatible with an embodiment of the present invention. Enablers include inter alia (i) manufacturers of mobile handsets who provide built-in capability to utilize an embodiment of the present invention with the handset, (ii) independent developers of software for mobile handsets who provide such capability, (iii) developers of e-book reading software, (iv) manufacturers of e-book reader devices, and (v) manufacturers of player devices or recorder devices, or developers of software for player devices or recorder devices who provide such capability.

Other vendors that enable operation of embodiments of the present invention are generally responsible inter alia for maintaining lists of consumers' content, for controlling access to consumers' content based on rights management and criteria such as consumer subscription levels, for providing technology enabling identification of consumers' content, and for tracking content distribution and consumer usage. In some instances, the other vendors that enable operation of embodiments of the present invention may also handle customer relationships, customer billing and collection, and serve as clearinghouses. Again, embodiments of the present invention support integration and revenue disbursement in all instances.

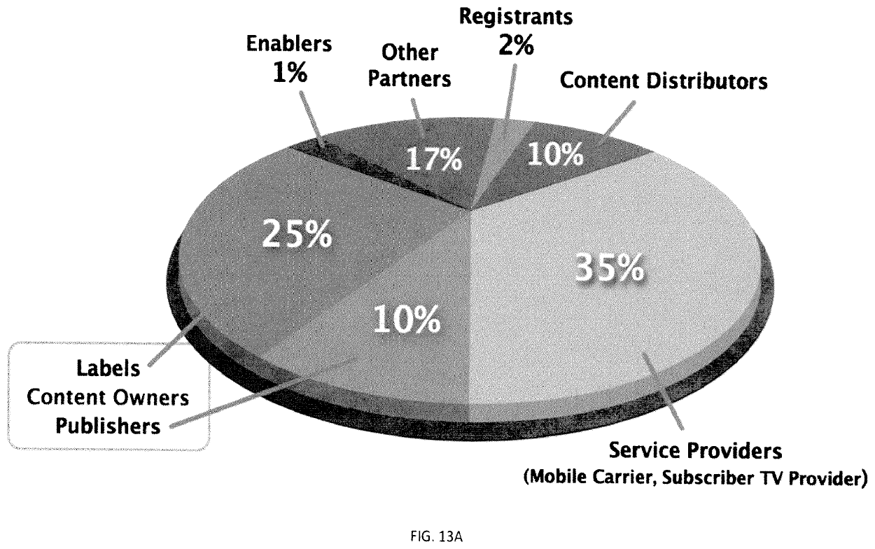

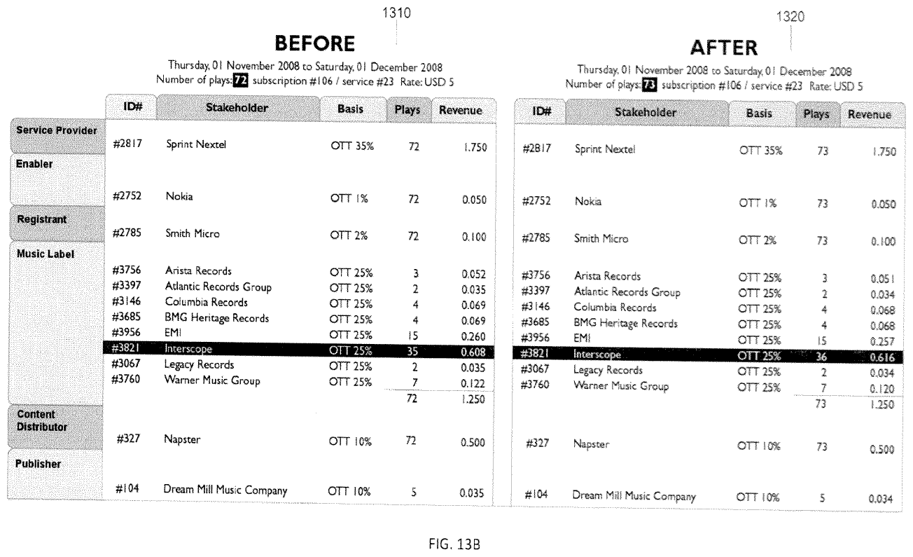

Reference is made to FIG. 13A, which is a diagram illustrating subscription revenue disbursement between content owners, content distributors, service providers, registrants, enablers and other partners, in accordance with an embodiment of the present invention. Shown in FIG. 13A is a revenue sharing formula that allocates 25% of a consumer's subscription revenue to music labels, 10% to music publishers, 35% to service providers, 2% to registrants, 10% to content distributors, 1% to enablers, and 17% to other partners.

Reference is made to FIG. 13B, which is an illustration of an accounting report for distributing the percentages allocated in FIG. 13A to the content owners, among a plurality of content owners, in accordance with an embodiment of the present invention. Shown in the accounting report are revenue portions for service providers (35% off the top), enablers (1% off the top), registrants (2% off the top), music labels (25% off the top), content distributors (10% off the top), and publishers (10% off the top), based on a subscription fee of $5. The 25% allocated to music labels is further distributed along eight labels; namely, Arista Records, Atlantic Records Group, Columbia Records, BMG Heritage Records, EMI, Interscope Records, Legacy Recordings and Warner Music Group. The inter-label distribution of revenue is based on the relative number of pieces of content played by the consumer from each label. Thus, as indicated in accounting report 1310, of 72 pieces of content played by the consumer during the time period Nov. 1, 2007-Dec. 1, 2007, 35 pieces are from the Interscope label. Accordingly, Interscope is allocated 35/72 of the 25% revenue; i.e., 35/72 of $1.25, which is $0.608.

If the consumer plays an addition piece of content from the Interscope label, then report 1310 is dynamically modified to report 1320, wherein the allocation to Interscope is dynamically adjusted upwards to 36/73 of the 25% revenue, which is $0.616. Similarly, the allocations of the 25% to the other labels are adjusted downwards, as indicated in report 1320.

It will be appreciated by those skilled in the art that tracking server 1280 generally determines relative frequencies f₁, f₂, . . . , fₙ with which a consumer uses content owned by label number k, during a specified time period, relative to the consumer's total usage of content, for each of n content labels k=1, 2, . . . , n. Revenue to the n content labels for the specified time period is then allocated based on the relative frequencies. In one embodiment of the present invention, fₖ is the number of pieces of content owned by label k and played by the consumer during the specified time period, relative to the total number of pieces of content played by the consumer during the specified time period. E.g., the relative frequencies indicated in report 1320 for the eight content labels are 3/73, 2/73, 4/73, 4/73, 15/73, 36/73, 2/73 and 7/73. These relative frequencies are the multipliers for allocating $1.25 of the subscription revenue earmarked for the labels, among the eight labels.

In another embodiment of the present invention, fₖ is the time spent by the consumer playing content owned by label k during the specified time period, relative to the total time spent by the consumer playing content during the specified time period.

In another embodiment of the present invention, fₖ is the number of the consumer's content items attributed to label k at the time of report generation, relative to the consumer's total inventory of content. This allocation may be applicable when there were no play events during a particular reporting period.

It will be appreciated by those skilled in the art that use of tracking server 1280 supports a wide variety of revenue allocation models including inter alia
sliding scale percentages, such as
   percentages that scale with volume,
   percentages that scale with content plays, and
   percentages that scale with numbers of registered users;
pre-established minimum amounts;
pro-rata splits;
off-the-top allocations; and
breakdown of leftover revenues, such as
   across the board breakdown,
   breakdown pro-rated by actual revenue breakdown for the period, and
   breakdown across members of a particular group.

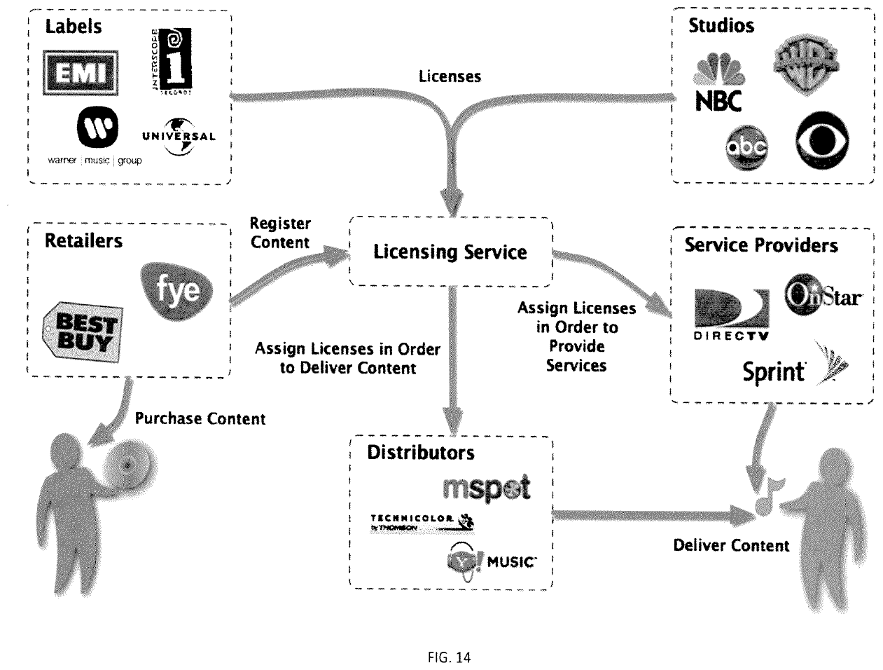

Reference is made to FIG. 14, which is a summary diagram of vendors in the content purchase and supply chain, integrated within a content licensing service, in accordance with an embodiment of the present invention. Shown in FIG. 14 are content labels, content studios, content distributors, content retailers and service providers, all integrated within a content licensing service. Each of the vendors shown in FIG. 14 is eligible to receive a portion of consumer subscription revenue.

### System Architecture

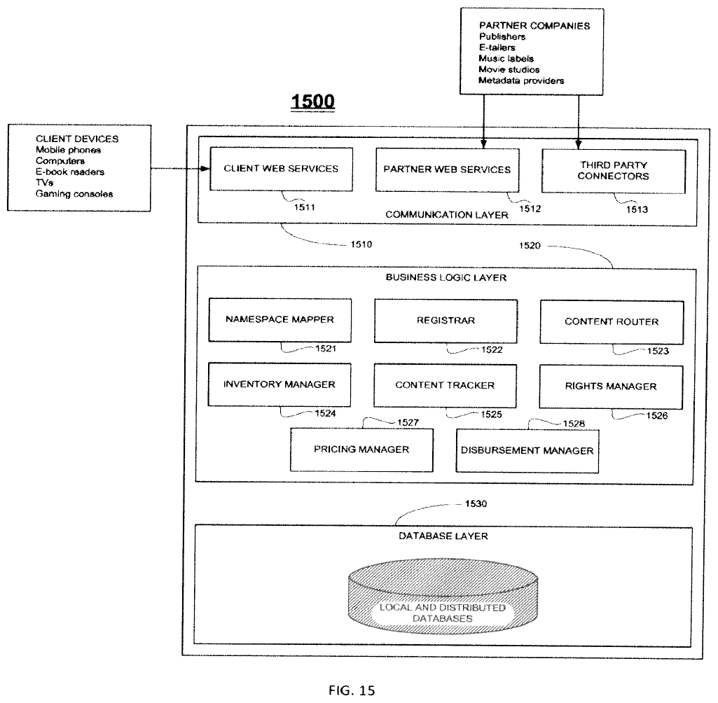

Reference is made to FIG. 15, which is a simplified high-level architecture diagram of a three-tier architecture of a digital asset registry, routing and tracking system 1500, in accordance with an embodiment of the present invention. The architecture includes a communication layer 1510, a business logic engine layer 1520, and a database layer 1530. It will be appreciated by those skilled in the art that a tiered architecture enables system 1500 to be deployed in a distributed manner, for purposes of scalability and robustness.

Communication layer 1510 controls communication between system 1500 and other systems. Communication with client devices including inter alia e-book reader devices, e-book reader applications, mobile phones, gaming consoles, media player devices and media player software, is managed by a set of client web services 1511. A device or application that implements a communication protocol compatible with client web services 1511 is able to make use of the services and features provided by system 1500.

Communication layer 1510 also includes a set of partner web services 1512. A company or other third party entity may use the features and services of system 1500 by implementing communication protocols compatible with partner web services 1512. Such companies include inter alia companies that may receive disbursements from system 100 as described hereinabove with reference to disbursement manager 180.

Communication layer 1510 also includes a set of third party connectors 1513. These connectors may be proprietary interfaces of entities that have not implement communication protocols that are compatible with partner web services 1512, to enable such entities nevertheless to benefit from integration into system 1500.

Business logic engine 1520 implements the logic described hereinabove with reference to the components of system 100, including inter alia business logic for modules 110-180 of FIG. 1. Correspondingly, business logic engine layer 1520 includes modules for a namespace mapper 1521, a registrar 1522, a content router 1523, an inventory manager 1524, a content tracker 1525, a rights manager 1526, a pricing manager 1527 and a disbursement manager 1528.

Database layer 1530 maintains one or more data stores for system 1500, including inter alia data stores for modules 110-180 of FIG. 1. Each of the modules of business logic layer 1520 writes to and reads from database layer 1530 as appropriate.

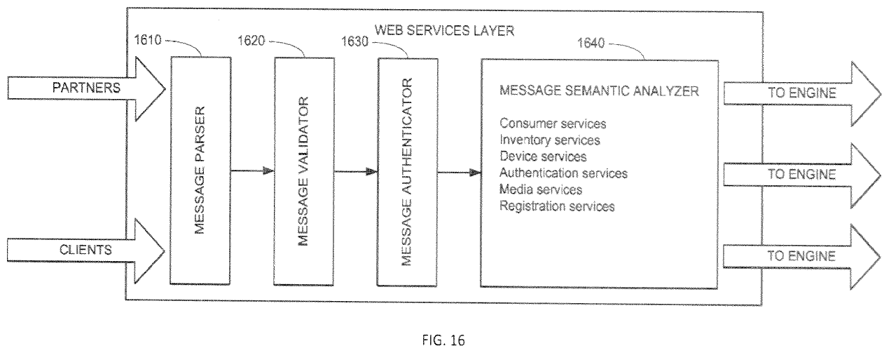

Reference is made to FIG. 16, which is a simplified architecture diagram of a web services layer 1600 of system 1500, in accordance with an embodiment of the present invention.

Web service messages entering web services layer 1600 are parsed by a message parser 1610, which performs lexical analysis on the message and breaks it into its component constructs. Message information is then passed to a message validator 1620, which performs a set of tests to determine whether or not the message is constructed correctly as per the web service protocol defined for web services layer 1600. A message that is constructed correctly is passed to a message authenticator 1630, which authenticates the message and the sender of the message by methods including inter alia (i) IP address filtering, (ii) session validation, and (iii) message signature using commonly available technologies such as PKI.

Messages that are thus parsed, validated and authenticated are passed to a semantic analyzer 1640, which analyzes the type of request being made, and routes it to the appropriate component of business logic layer 1520.

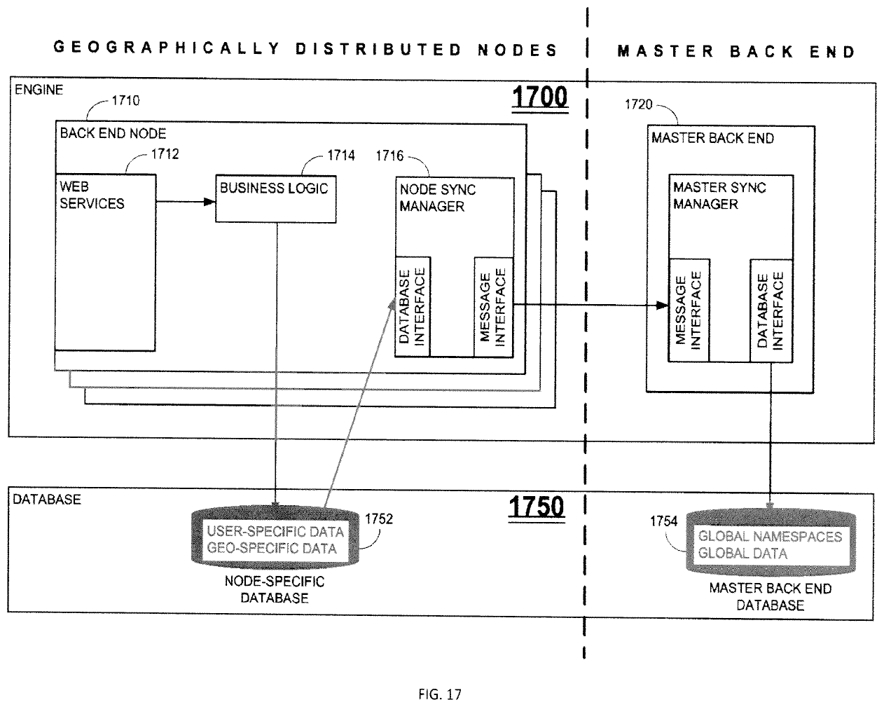

Reference is made to FIG. 17, which is a simplified architecture diagram of an engine layer 1700 and a database layer 1750 of system 1500, in accordance with an embodiment of the present invention.

Engine layer 1700 may contain multiple back end nodes 1710. Each such back end node 1710 services a specific subset of consumers or devices that communicate with system 1500. The allocation of consumers and devices between different back end nodes 1710 may be inter alia geographic or service based.

Database layer 1750 contains a node-specific database 1752 and a master back end database 1754. Each instance of a node-specific database 1752 contains data associated with and maintained by a single instance of a back end node 1710. Such data may include inter alia consumer media data for the consumers serviced by the database's specific back end node 1710.

Master back end database 1754 exists in only one instance for system 1500, and contains data that is common across all back end nodes 1710.

Engine layer 1700 also includes master back end 1720, which serves to synchronize back end nodes 1710 with master back end database 1754.

It will be appreciated by those skilled in the art that the breakdown of engine 1700 into back end nodes 1710 and master back end 1720 is one of several mechanisms that enable system 1500 to achieve massive scalability.

Each instance of a back end node 1710 includes a web services layer 1712, a business logic layer 1714, and a node synchronization manager 1716.

Web services layer 1712 receives communications from web services 1510, Business logic layer 1714 implements core business logic of system 1500.

Node synchronization manager 1716 provides data to master back end 1720. Master back end 1720 propagates data to master back end database 1754, and then to other instances of node specific database 1752.

It will be appreciated by those skilled in the art that segmenting database layer 1750 into non-specific databases 1752 and master back end database 1754, is one of several mechanisms enabling system 1500 to be massively scalable.

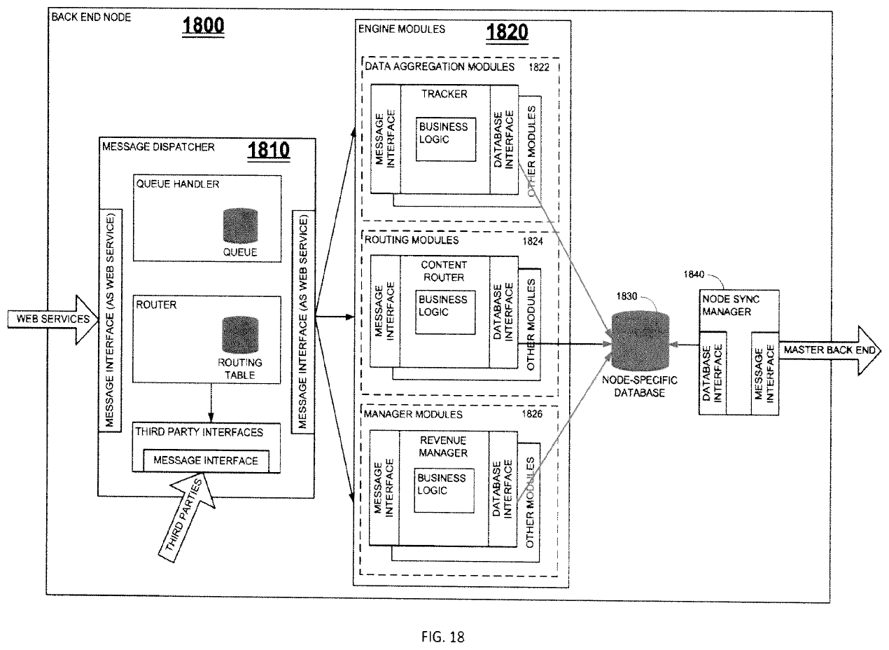

Reference is made to FIG. 18, which is a simplified architecture diagram of a back end node 1800 of system 1500, in accordance with an embodiment of the present invention. Back end node 1800 is an instance of back end node 1710.

Back end node 1800 receives requests from partners and client devices, as described hereinabove. Partners include inter alia owners of media content, and providers of media content. Client devices include inter alia e-book readers, mobile phones, portable media players and automobile decks. Back end note 1800 uses a message dispatcher 1810 to forward messages to a set of engine modules 1820, such modules implementing the core business logic of engine 1700.

Back end node 1800 also contains a node-specific database 1830, corresponding to node-specific database 1752, and a node synchronization manager 1840, corresponding to node synchronization manager 1716.

Message dispatcher 1810 manages incoming requests and routes them to their appropriate destinations. The destinations may be internal to system 1500, such as engine modules 1820, or external to system 1500, such as content owners and content distributors.

Engine modules 1820 implement core functionality of system 1500. An engine module generally exists for each of the server components shown in FIG. 1. Additional modules may exist to provide additional functionality, or to provide support functionality for the components of FIG. 1.

Engine modules 1820 are broken up into data aggregation modules 1822, routing modules 1824 and manager modules 1826. It will be appreciated by those skilled in the art that this breakdown is artificial, and is made herein for the sake of clarity in understanding roles of the different modules. Data aggregation modules 1822 include inter alia content tracker 150. Routing modules 1824 include inter alia content router 130. Manager modules 1826 include inter alia rights manager 160 and disbursement manager 180.

Each engine module 1820 maintains its relevant data store in node-specific database 1830. Node-specific database 1830 is synchronized with master back end database 1754 via node synchronization manager 1840, as described hereinabove.

### Insuring Digital Assets

The present invention is of advantage to appraising and insuring inventories of digital assets. The present invention is of advantage to consumers, who invest substantial money in accumulating personal collections of media and other digital assets, by providing them with an accurate registry of their digital assets and the rights they have thereto, and enabling them to insure their collections against loss and theft. The present invention is also of advantage to insurance companies, by enabling them to insure people's valuable media inventories with accurate appraisal value, and to process claims for lost or stolen media items.

Moreover, the present invention also provides insurers with an easy mechanism to replace lost or stolen media collections. Media may be replaced in the same physical or non-physical form that it had prior to loss or theft; i.e., physical CDs may be replaced with physical CDs and computer media files may be replaced with computer media files.

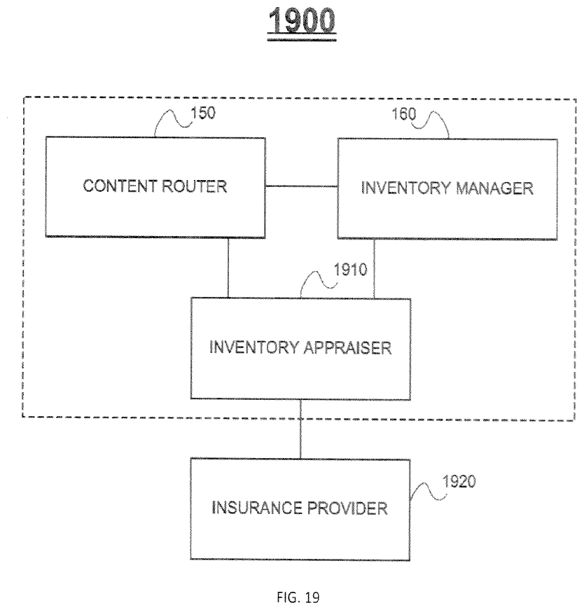

Reference is made to FIG. 19, which is a simplified block diagram of a system for appraising an inventory of digital assets, in accordance with an embodiment of the present invention. Shown in FIG. 19 are two components of system 100, namely, content router 130 and inventory manager 140. As described hereinabove with reference to FIG. 10, inventory manager 140 maintains information regarding a consumer's registered digital asset inventory. In addition, inventory manager 140 has access to the consumer's registered rights to the digital assets in his inventory, via rights manager 160. As described hereinabove with reference to FIG. 8, content router 130 maintains a data store of content sources, and of information regarding the content provided by the sources including inter alia media format.

By combining the information available to content router 130 and inventory manager 140, it is possible to derive an appraisal value for the consumer's inventory of digital assets. For each digital asset in the consumer's inventory, an inventory appraiser 1910 determines the cost of purchasing the consumer's registered rights for the digital asset from an appropriate content source identified by content router 130. Inventory appraiser 1910 accumulates the individual costs to derive an appraisal value for the consumer's entire inventory.

In accordance with an embodiment of the present invention, inventory appraiser 1910 interfaces with an insurance provider system 1920, which uses the appraisal to calculate an insurance premium for insuring the consumer's media content inventory.

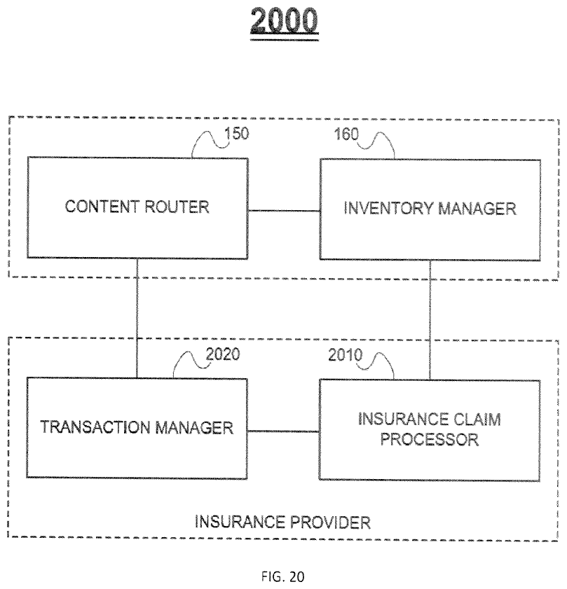

Reference is made to FIG. 20, which is a simplified block diagram of a system for insuring an inventory of digital assets, in accordance with an embodiment of the present invention. In addition to content router 130 and inventory manager 140, shown in FIG. 20 is an insurance claim processor 2010 and a transaction manager 2020. Insurance claim processor 2010 receives a claim from a consumer for one or more digital assets that are lost or stolen. Insurance claim processor 2010 consults with inventory manager 140 to determine the consumer's registered rights to each of the claimed digital assets. Digital assets for which the consumer does not have registered rights are removed from the insurance claim. The remaining digital assets are transmitted to transaction manager 2020 for recovery.

Transaction manager 2020 consults with content router 130 to identify an appropriate content source, for each digital asset in the insurance claim. Transaction manager 2020 proceeds to acquire the registered rights to the digital asset, for recovery to the consumer.

If a digital asset cannot be obtained from a content source, such as a private digital asset, inventory manager 140 saves a copy of the digital asset for recovery purposes.

In accordance with an embodiment of the present invention, inventory claim processor 2010 and transaction manager 2120 are components of an insurance provider system, which insures the consumer's media content inventory.

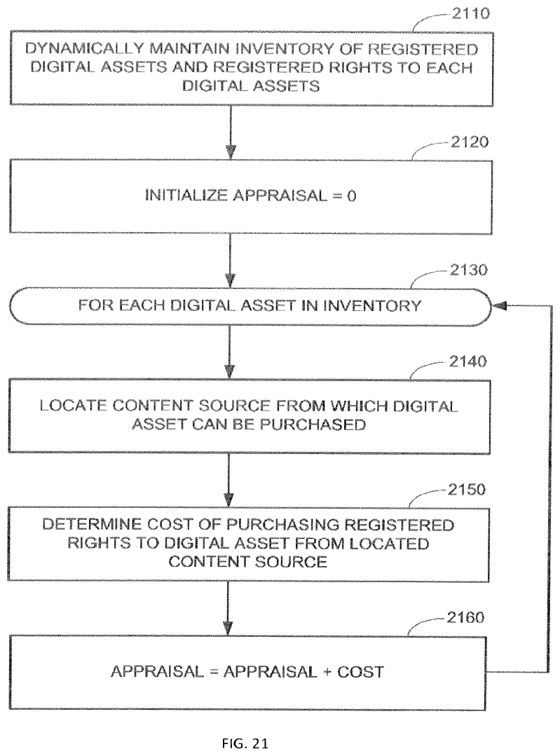

Reference is made to FIG. 21, which is a simplified flowchart of a method for appraising an inventory of digital assets, in accordance with an embodiment of the present invention. At step 2110 an inventory manager dynamically maintains a current inventory of digital assets belonging to a consumer, and the rights that the consumer has to each digital asset. At step 2120 an appraisal value is initialized to zero.

At step 2130 a processing loop processes each digital asset in the consumer's inventory. At step 2140 a content source, from which the digital asset may be purchased, is identified. At step 21250 a cost of purchasing the rights that the customer has to the digital asset, from the content source identified at step 2140, is determined. At step 2160 the cost determined at step 2150 is added to the appraisal value, which thus accumulates the total cost for replacing the entire inventory.

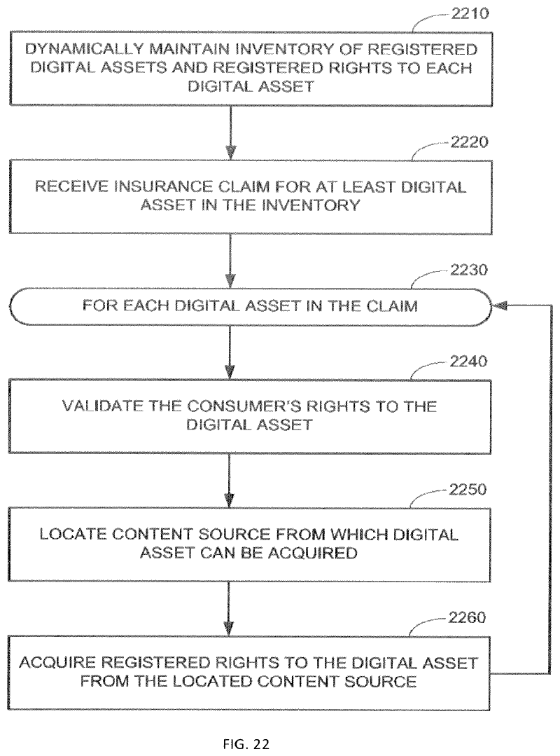

Reference is made to FIG. 22, which is a simplified flowchart of a method for insuring an inventory of digital assets, in accordance with an embodiment of the present invention. At step 2210 an inventory manager dynamically maintains a current inventory of digital assets belonging to a consumer, and the rights that the consumer has to each digital asset. At step 2220 an insurance claim is received for one or more digital assets from the consumer's inventory. The insurance claim may relate to the entire inventory, in case of loss or theft thereof, or to a portion of the entire inventory.

At step 2230 a processing loop processes each digital asset in the insurance claim. At step 2240 the rights that the consumer has to the digital asset are validated, to ensure that the consumer has currently valid rights thereto. At step 2250 a content source, from which the digital asset may be acquired, is identified. If a digital asset cannot be obtained from a content source, such as a private digital asset, a copy of the digital asset is saved for recovery purposes.

At step 2260 the digital asset is acquired from the content source identified at step 2250, and the digital asset in the consumer's inventory that was lost or stolen is replaced with the newly acquired item.

In some embodiments of the present invention, the loop over steps 2240-2260 is performed in two separate loops. A first loop, performed by an insurance claim processor, such as insurance claim processor 2010 of FIG. 20, validates digital assets in the insurance claim at step 2240, and prepares a list of validated claimed digital assets. A second loop, performed by a transaction manager, such as transaction manager 2020 of FIG. 20, identifies a content source for each validated digital asset at step 2250, and acquires the consumer's registered rights to the digital asset at step 2260.

It will be appreciated by those skilled in the art that the systems and methods of FIGS. 19-22 are applicable to consumers that own media collections, whether or not the consumers are subscribers to the content provisioning and revenue disbursement system 100 of FIG. 1. I.e., consumers who do not benefit from the content provisioning may nevertheless benefit from the appraisal and insurance features that are enabled by components of system 100. Consumers who simply purchase their digital assets at media retail stores, without use of a PC, may use the present invention to insure their media collections, and insurance companies may use the present invention to provide such insurance coverage.

It will also be appreciated by those skilled in the art that the systems and methods of FIGS. 19-22 are applicable to media archives owned by museums or other such entities that collect media.

### E-Used Digital Assets

The present invention is of advantage in resale of digital assets, referred to herein as sale of “e-used digital assets”. The term “e-used” is used herein to refer to a post-acquisition transaction in the form of sale or a loan of a digital asset that was previously purchased. For example, a consumer who purchased an electronic book (“e-book”) may, using the present invention, resell the e-book if he is no longer interested in owning it, at a price expected to be less than the price he originally paid for the e-book.

It will be appreciated by those skilled in the art that by enabling reselling of digital assets, the present invention enables a wide variety of commercial opportunities for post-acquisition transactions and revenue. Referring to the e-book example, prior art e-book e-commerce systems enable publishers to sell e-books through e-tailers, such as Amazon and Barnes & Noble, through the e-tailer's on-line stores, for presentation on e-book readers. Thus e-tailer Amazon sells e-books through its on-line store for the KINDLER, e-tailer Barnes & Noble sells e-books through its on-line store for the NOOK®, and e-tailer Apple sells e-books through its on-line store for the IPAD®. Each publisher distributes its books through a single e-tailer or through multiple e-tailers, and the e-tailers disburse royalty payments to the respective publishers as the publishers' e-books are sold. In these prior art systems, the sale and revenue opportunity ends at the point when an e-tailer sells a book to a consumer.

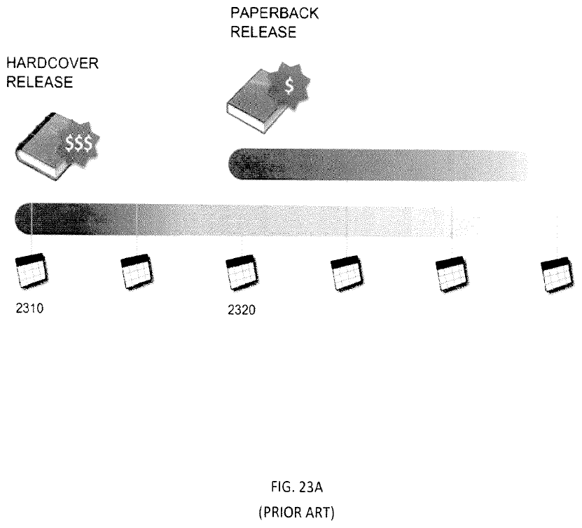

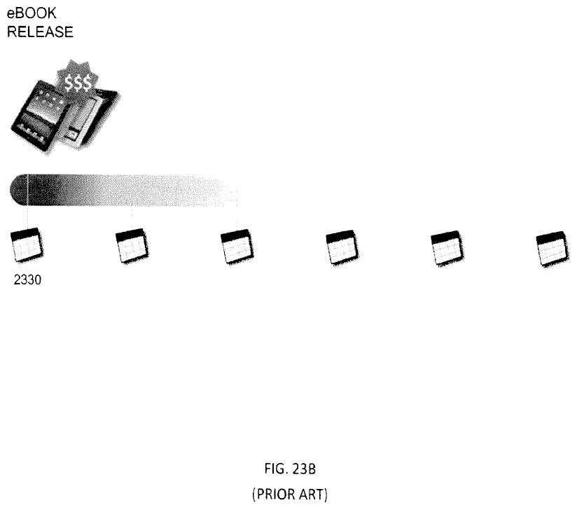

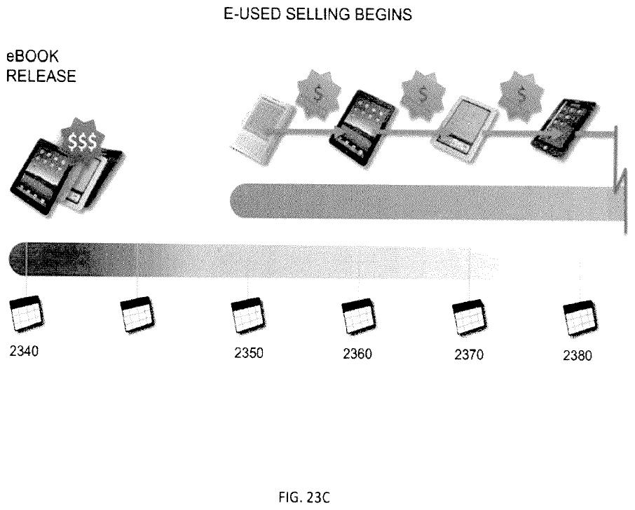

Reference is made to FIGS. 23A and 23B, which are illustrations of release timelines of prior art release models for physical books and e-books. As shown in FIG. 23A, prior art physical book release models allow for two stages that create revenue opportunities for a publisher and a retailer; namely, a hardcover release stage 2310 and a paperback release stage 2320. As shown in FIG. 23B, prior art e-book release models allow for a single stage, creating a revenue opportunity for the publisher and an e-book e-tailer at the time of an e-book release stage 2330.

Reference is made to FIG. 23C, which is an illustration of a release timeline for e-books, in accordance with an embodiment of the present invention. As shown in FIG. 23C, when an e-book is enabled for e-used sales, multiple new revenue opportunities are created. A revenue opportunity remains at the initial stage 2340 of e-book release, and additional revenues are realized each time an e-used sale occurs at respective stages 2350, 2360, 2370 and 2380.

The present invention enables second digital tiers, for generating post-acquisition revenues for publishers, e-tailers and consumers, through sale of e-used books. The second tier allows consumers to sell their purchased e-books to other consumer across e-tailers. The second tier allows publishers to re-monetize e-books multiple times after an initial sale, and to better target the consumer market through multiple e-tailers.

Using the present invention, a publisher can permit e-tailers to offer one or more of its e-books for resale, as an e-used book, by issuing a resale permission instruction to the registry of registries. Upon receiving the resale permission instruction, the e-tailer who initially sold the one or more e-books notifies the consumers, via its on-line store, of the opportunity to resell the one or more e-books. In turn, an interested consumer indicates his willingness to resell his e-book, and the e-used book is registered as being for sale across multiple e-tailers. Thus a consumer is able to purchase the e-used book through an e-tailer, from a consumer who initially purchased the e-book through a different e-tailer.

A typical use case scenario is as follows.
i. John purchases the e-book “Roots”, published by Vanguard Press, from Amazon for his KINDLER in January 2010.
ii. Vanguard Press issues a resell permission instruction for Roots on Nov. 1, 2010, and Amazon posts a notification that Roots may be resold.
iii. John decides to resell his copy of Roots for $7.99, of which he would receive $1.99, on Nov. 5, 2010, and John's e-used book Roots is entered for sale across multiple e-tailers.
iv. Jane, who has a NOOK®, sees John's e-book for sale as an e-used book on her NOOK®, and decides to purchase it for $7.99 on Nov. 6, 2010, which she pays to Barnes and Noble. The $7.99 is allocated as shown in TABLE II.

TABLE II
Allocation of e-Used Book Revenue

| | | E-Used Price | $7.99 |
|---|---|---|---|
| Publisher | Vanguard Press | 30% | $2.40 |
| Initial Selling e-Tailer | Amazon | 15% | $1.20 |
| Consumer | John | 25% | $2.00 |
| e-Used Selling e-Tailer | Barnes & Noble | 20% | $1.60 |
| Registration, Tracking | Catch Media | 10% | $0.79 |
| and Clearing Provider | | | |

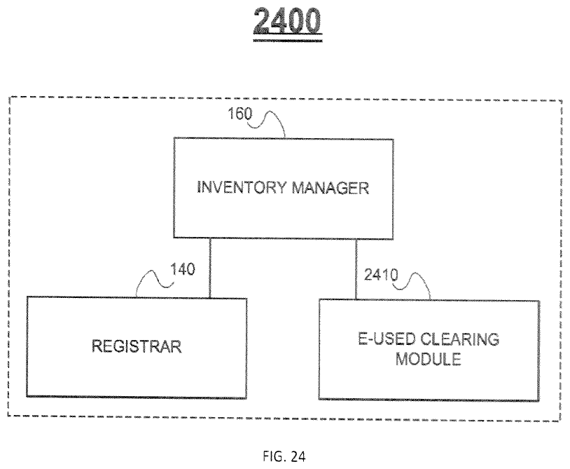

Reference is made to FIG. 24, which is a simplified block diagram of a system 2400 for resale of digital assets, in accordance with an embodiment of the present invention. Shown in FIG. 24 are registrar 120, inventory manager 140, and an e-used clearing module 2410. Registrar 120 registers purchase of a digital asset by a first consumer, C1 from a first e-tailer, E1. The digital asset is published by a publisher, P. The digital asset may be inter alia an e-book, a video, a song, a game or a software application. Customer C1 owns one or more first devices, D1, which present the digital asset to him.

In response to a resale permission instruction from publisher P, e-tailer E1 notifies customer C1 that he has permission to offer the digital asset for re-sale, as an e-used digital asset. Subsequently, in response to receipt of a resale request instruction from customer C1, the e-used digital asset is advertised for resale on the on-line stores of a plurality of e-tailers. Upon resale of the e-used digital asset by an e-tailer, E2, who may or may not be the same e-tailer as E1, registrar 120 registers purchase of the e-used digital asset. The purchaser of the e-used digital asset may be a second consumer, C2, who owns one or more second devices, D2, which present the digital asset to him. Alternatively, the purchaser of the e-used digital asset may be an e-tailer or another entity.

The price paid by the purchaser of the e-used digital asset is expected to be less than the initial price paid by C1 for the e-book. However, this need not be the case, and in certain circumstances the price paid for the e-used digital asset may be the same as or higher than the initial price paid by C1.

Upon sale of the e-used digital asset, e-used clearing module 2410 prevents the at least one first device D1 from presenting the digital asset. E-used clearing module also determines allocation of the price paid for the e-used digital asset among at least participants C1, P, E1, E2 and a service provider who provides system 2400; e.g., as in TABLE II. Alternatively, consumer C1 may be allocated a credit towards purchase of digital assets, by publisher P, or by e-tailer E1, or by e-tailer E2, instead of cash.

At consumer C1's discretion, the resale request instruction may be automatically generated in response to publisher P's resale permission instruction. As such, consumer C1 can register in advance to re-sell his digital asset as soon as publisher P grants permission to do so.

In accordance with an embodiment of the present invention, a resold digital asset may be further resold, up to a designated maximum number of times. Thus, consumer C1 may sell his digital asset as an e-used digital asset to consumer C2; and consumer C2 may later resell his e-used digital asset to a consumer C3. The inherent limit on the maximum number of times the digital asset may be resold typically drives the selling price down upon each successive sale.

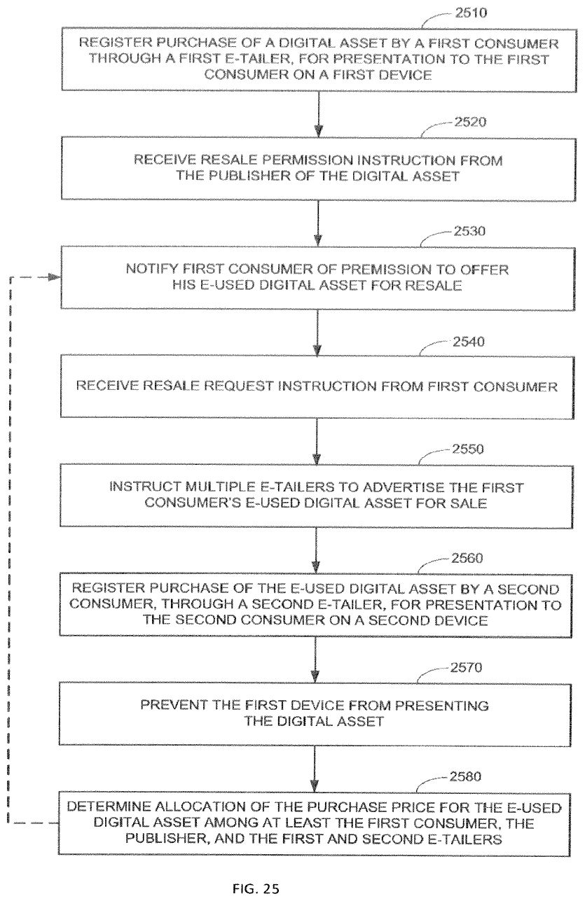

Reference is made to FIG. 25, which is a simplified flowchart of a method for resale of digital assets, in accordance with an embodiment of the present invention. At step 2510 the purchase of a digital asset by a first consumer, C1, through a first e-tailer, E1, for presentation to consumer C1 on a first device, D1, or on a plurality of first devices, is registered. At step 2520 a resale permission instruction is received from the publisher, P, of the digital asset. The resale permission instruction may be manually generated by publisher P or, at publisher P's discretion, may be automatically generated upon occurrence of a trigger event, as described hereinabove with reference to rights manager 160.

At step 2530 consumer C1 is notified that he has permission to resale his digital asset, as an e-used digital asset. At step 2540 a resale request instruction is received from consumer C1. The resale request instruction may be manually generated by consumer C1 or, at consumer C1's discretion, may be automatically generated in response to publisher P's resale permission instruction. As such, consumer C1 can register in advance to re-sell his digital asset as soon as publisher P grants permission to do so. At step 2550 multiple e-tailers are instructed to advertise consumer C1's e-used digital asset for sale.

Upon purchase of the e-used digital asset by a buyer, the purchase is registered at step 2560. The buyer may be a second consumer who buys the e-used digital asset through a second e-tailer, E2, not necessarily the same e-tailer as E1, or the buyer may be one of the e-tailers, or the buyer may be a third party entity.

At step 2570 device D1 is prevented from presenting the digital asset. Step 2570 may be performed by removing the digital asset from device D1. Alternatively, step 2570 may be performed by disabling device D1 from presenting the digital asset.

At step 2580 an allocation of the purchase price paid for the e-used book is determined among at least publisher P, consumer C1 and e-tailers E1 and E2, such as the sample allocation shown in TABLE II. Alternatively, consumer C1 may be allocated a credit towards purchase of digital assets, by publisher P, by e-tailer E1 or by e-tailer E2, instead of cash.

As shown by the dashed arrow in FIG. 25, steps 2530-2580 may be repeated up to an allowed maximum number of times, thereby enabling the digital asset to be resold by successive buyers multiple times. Thus, consumer C1 may sell his digital asset as an e-used digital asset to consumer C2; and consumer C2 may later resell his e-used digital asset to a consumer C3. The inherent limit on the maximum number of times the digital asset may be resold typically drives the selling price down, each successive sale.

In an embodiment of the present invention, an asset resale such as that illustrated in FIG. 25, is executed by a retailer or retailers, where the e-used asset is sold from one consumer to a second consumer.

In another embodiment of the present invention, a retailer may purchase e-used assets offered for sale by consumers without having a buyer available to purchase the asset. In this case the retailer creates an inventory of e-used assets for future sale. It will be appreciated by those skilled in the art that a retailer may thus cause scarcity in a market for a particular e-used asset, and thereby drive up the value of the asset.

In yet another embodiment of the present invention, a resale of an e-used asset may be effected from one consumer directly to a second consumer, without a retailer to facilitate the transaction. E.g., an embodiment of the present invention may be used to facilitate sale of a digital asset that a consumer has offered for sale on a site such as EBAY®.

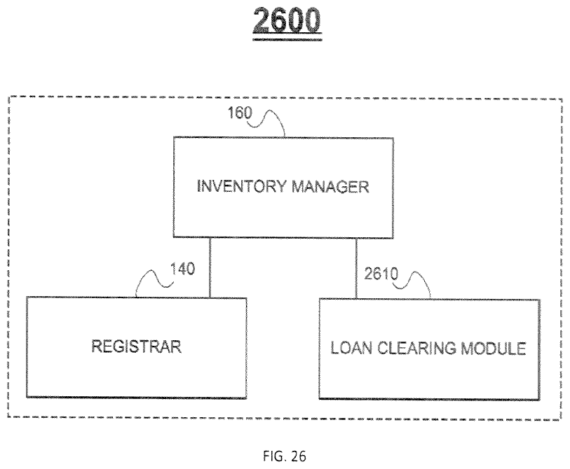

The present invention is also of advantage in providing a system for lending digital assets, whereby a first consumer, C1, lends his digital asset to a second consumer, C2, for the duration of a loan period, either with or without a lending fee. Reference is made to FIG. 26, which is a simplified block diagram of a system for lending of digital assets, in accordance with an embodiment of the present invention. Shown in FIG. 26 are registrar 120, inventory manager 140, and a loan clearing module 2610. Registrar 120 registers purchase of a digital asset by a first consumer, C1 from an e-tailer, E. The digital asset is published by a publisher, P. The digital asset may be inter alia an e-book, an audiobook, a video, a song, a game or a software application. Consumer C1 owns one or more first devices, D1, which present the digital asset to him.

Upon issuance of a lending permission instruction from publisher P, consumer C1 is enabled to offer the digital asset for loan to another designated or undesignated consumer. The loan extends for a specific loan period, and may require payment of a lending fee. Upon exercise of the loan to a consumer, C2, registrar 120 registers the loan of the digital asset to consumer C2, for presentation on one or more second devices D2. In turn, loan clearing module 2620 prevents device D1 from presenting the digital asset for the duration of the loan period, and enables device D2 to present the digital asset. Loan clearing module 2620 determines an allocation of the lending fee paid by consumer C2, if any, among one or more entities such as inter alia publisher P, consumer C1 and e-tailer E.

After termination of the loan period, loan clearing module re-enables device D1 to present the digital asset, and prevents device D2 from further presenting the digital asset.

At publisher P's discretion, the lending permission instruction may be manually generated by publisher P, or automatically generated upon occurrence of a trigger event, as described hereinabove with reference to rights manager 160.

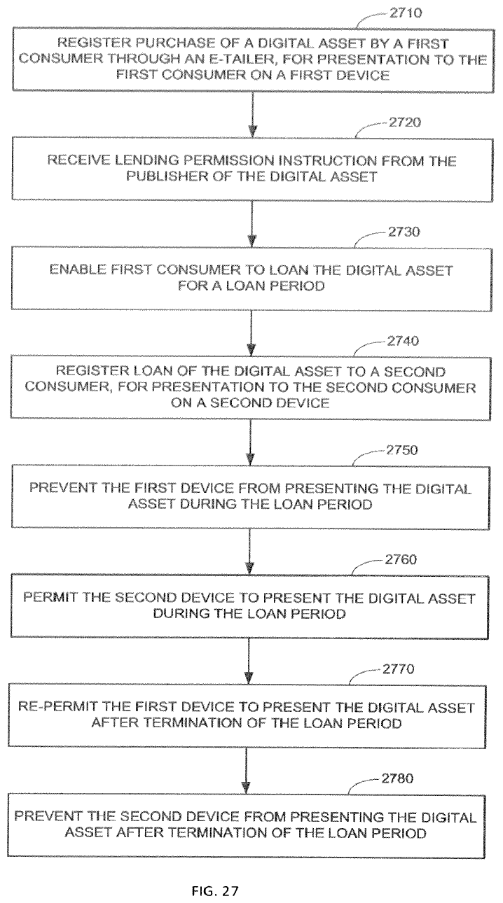

Reference is made to FIG. 27, which is a simplified flowchart of a method for lending digital assets, in accordance with an embodiment of the present invention. At step 2710 the purchase of a digital asset by a first consumer, C1, through an e-tailer, E, for presentation to consumer C1 on a first device, D1, or on a plurality of first devices, is registered. At step 2720 a lending permission instruction is received from the publisher, P, of the digital asset. The lending permission instruction may be manually generated by publisher P or, at publisher P's discretion, may be automatically generated upon occurrence of a trigger event, as described hereinabove with reference to rights manager 160.

At step 2730 consumer C1 is enabled to loan the digital asset to a designated or undesignated consumer. Upon exercise of the loan to a second consumer, C2, for presentation to consumer C2 on a second device D2, or on a plurality of second devices, the loan is registered at step 2740.

At step 2750 device D1 is prevented from presenting the digital asset for the duration of the loan period. Step 2750 may be performed by removing the digital asset from device D1. Alternatively, step 2750 may be performed by disabling device D1 from presenting the digital asset. At step 2760 device D2 is permitted to present the digital asset, for the duration of the loan period. Step 2760 may include providing the digital asset to device D2 for storage thereon.

At step 2780 device D1 is re-permitted to present the digital asset, after termination of the loan period. At step 2790 device D2 is prevented from further presenting the digital asset, after termination of the loan period.

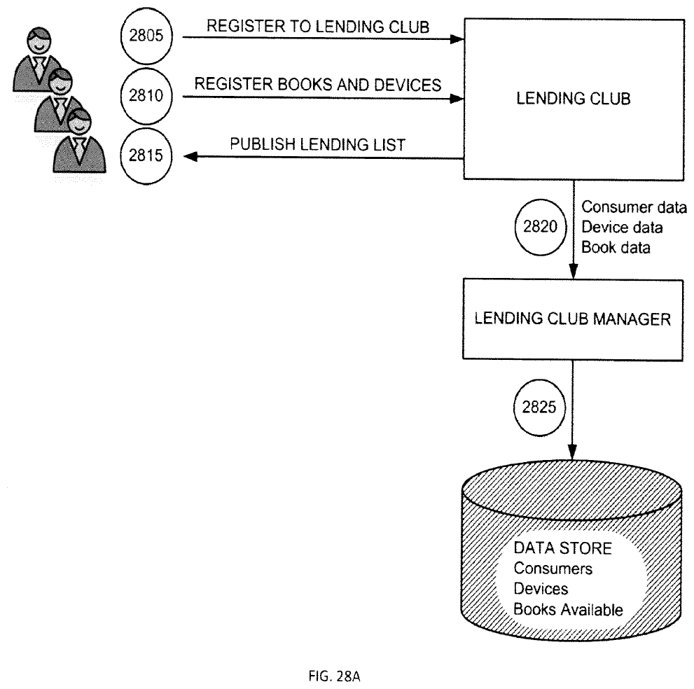

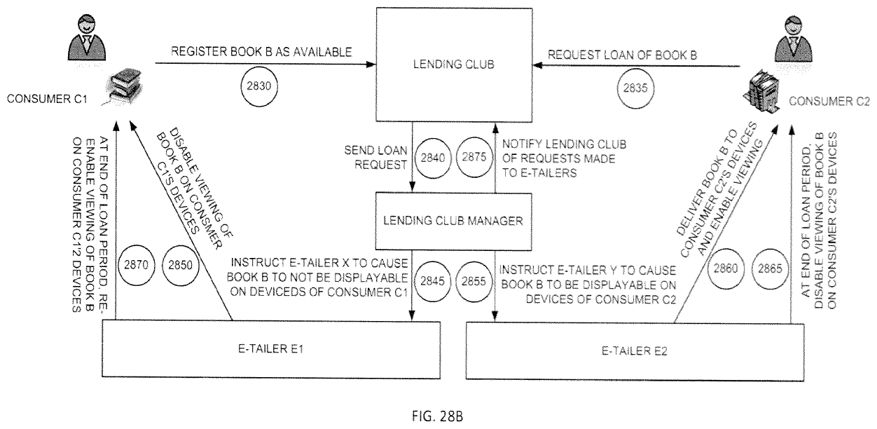

In an embodiment of the present invention, permission to lend digital assets may be granted to consumers who join a “lending club”. Members of such a club may be charged a fee for joining the club, and are granted permission to lend their digital assets that have been registered, to other members of the club. Reference is made to FIGS. 28A and 28B, which are simplified diagrams of an e-book lending club, in accordance with an embodiment of the present invention. At step 2805 one or more consumers register to join a lending club operated by a third party entity. At step 2810 the one or more consumers register their e-book libraries and their e-book readers with the lending club. At step 2815 the lending club publishes to each of its members a list of all titles available for lending by the members. At step 2820 the lending club provides data regarding books available for loan to a lending club manager. At step 2825 the lending club manager stores data about consumers, devices and books available for lending in a data store.

A step 2830 a consumer, C1, registers one of his books, say book B, with the lending club as being available for lending. Consumer C1 owns an e-book reader, say an IPAD®. At step 2835 another consumer, C2, sees that book B is available, and requests a loan of the book from the lending club. Consumer C2 owns an e-book reader, say a KINDLE®.

At step 2840 the lending club issues a request to the lending club manager for a loan of book B from consumer C1 to consumer C2. At step 2845 the lending club manager issues a request to the e-tailer, E1, who originally sold book B to consumer C1, to disable consumer C1's IPAD® from reading book B. At step 2850, e-tailer E1, in this case Apple, causes book B to be unreadable on consumer C1's IPAD®.

At step 2855 the lending club manager instructs an e-tailer, E2, in this case Amazon, to deliver book B to consumer C2's devices and enable it for reading. At step 2860 e-tailer E2 executes the requested delivery and enablement.

When the end of the loan period arrives, at step 2865 e-tailer E2 causes book B to not be readable on consumer C2's devices, and at step 2870 e-tailer E1 re-enables consumer C1's devices to read book B.

At step 2875, which occurs throughout the process of FIG. 28B, the lending club manager informs the lending club of all requests and statuses, so that the lending club may update its members accordingly.

In such a lending club, a clearing module, such as clearing module 2620, determines an allocation of the fees paid by the club members inter alia between the publishers of the books registered for lending or the publishers of the books actually loaned, and one or more e-tailers who facilitated the loans.

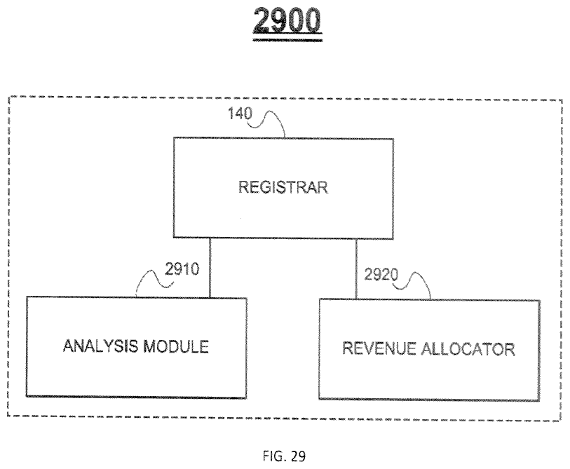

The present invention is also of advantage in providing a market for buying and selling e-used digital asset, determining an appropriate market price therefor, and creating liquidity in the market. Reference is made to FIG. 29, which is a simplified block diagram of a system for determining a market price for a digital asset, in accordance with an embodiment of the present invention. Shown in FIG. 29 is registrar 120, an analysis module 2910 and a revenue allocator 2920. Registrar 120 registers one or more offers to sell a digital asset, by respective one or more consumers who purchase the digital asset through an e-tailer, E, and who obtained permission from the publisher, P, of the asset to resell the digital asset. Registrar 120 also registers one or more offers to buy the digital asset by respective one or more potential buyers.

Analysis module 2910 analyzes the offers to sell and offers to buy which were registered by registrar 120, and determines a price for the digital asset based on supply and demand. Revenue allocator 2920 allocates the revenue among one or more of inter alia publisher P, e-tailer E and the sellers.

Publisher P may constrain the resell price; e.g., publisher P may require that the price be at least $2.00.

Analysis module 2910 also determines a priority order for processing the offers to sell, based on one or more of the following factors: (i) the respective prices of the offers to sell, (ii) the order in which the offers to sell were registered by registrar 120, and (iii) the selling or buying history of the respective one or more consumers making the offers to sell.

In accordance with an embodiment of the present invention, each offer to sell may include a respective number of copies of the digital asset offered for sale. Analysis module 2910 may also base the priority order to processing the offers to sell on (iv) the respective number of copies of the digital asset offered for sale in each offer to sell.

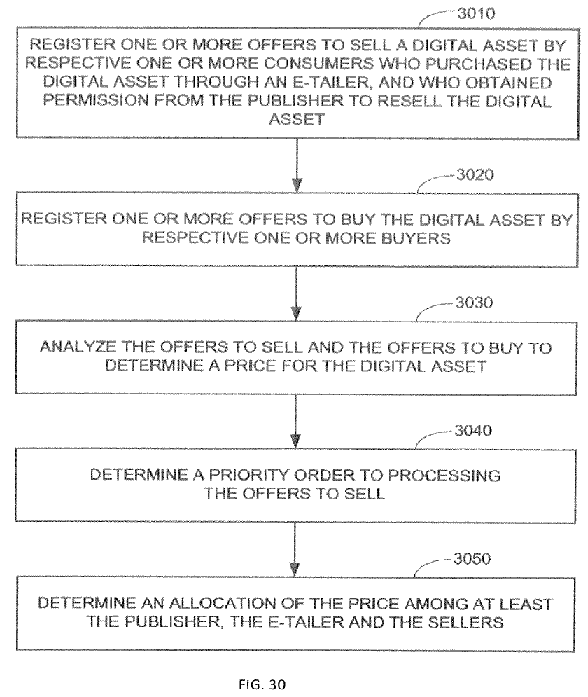

Reference is made to FIG. 30, which is a simplified flowchart of a method for determining a market price for a digital asset, in accordance with an embodiment of the present invention. At step 3010 one or more offers to sell a digital asset by respective one or more consumers who purchased the digital asset through an e-tailer, and who obtained permission from the publisher of the digital asset to resell the digital asset, are registered. At step 3020 one or more offers to buy the e-used digital asset by respective one or more potential buyers are registered.

At step 3030 the offers to sell and the offers to buy that were registered, are analyzed to determine a price for the digital asset based on supply and demand. At step 3040 a priority order to processing the offers to sell is determined, based on one or more of the following factors: (i) the respective prices of the offers to sell, (ii) the order in which the offers to sell were registered, and (iii) the selling or buying history of the respective one or more consumers making the offers to sell.

In accordance with an embodiment of the present invention, each offer to sell may include a respective number of copies of the digital asset offered for sale. Step 3040 may also be based on (iv) the respective number of copies of the digital asset offered for sale in each offer to sell.

At step 3050 the price paid for the digital asset by the potential buyers is allocated among one or more of inter alia the publisher, the e-tailer and the sellers.

In an embodiment of the present invention, analysis module 2910 enables an entity to establish a market for digital assets. Based on the pricing analysis of analysis module 2910, the entity determines an equitable buy price and sell price for a given digital asset, and buys up assets offered for resale at its determined price, whenever a consumer offers an asset for sale at a minimum price that is at or below the buy price determined by the market. In this manner the entity ensures liquidity in a market for digital assets, in the same way that a market maker in a stock exchange ensures liquidity in stocks and other securities.

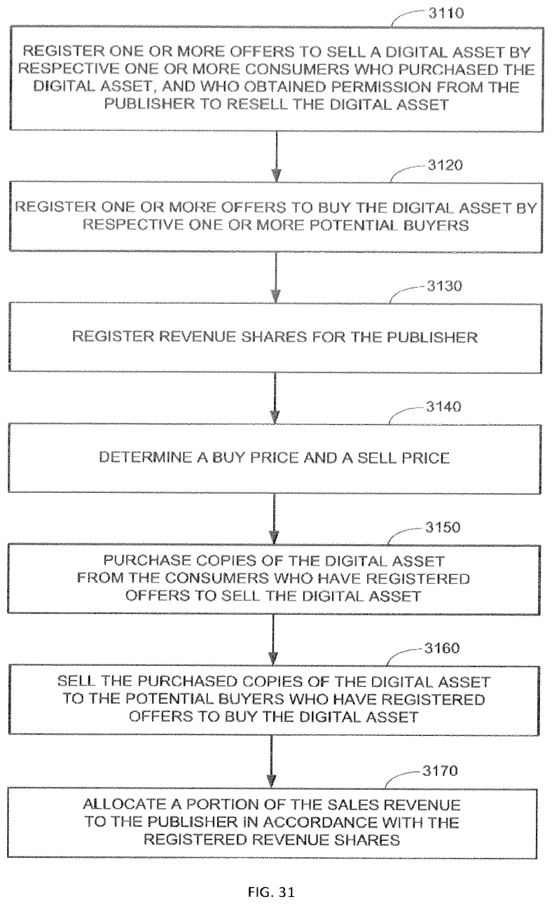

Reference is made to FIG. 31, which is a simplified flowchart of a method for creating a market for digital assets, in accordance with an embodiment of the present invention. At step 3110, one or more offers are registered to sell a digital asset published by a publisher are, by respective one or more consumers who own the digital asset and who have obtained permission from the publisher to sell the digital asset at a price range specified by the publisher. At step 3120, one or more offers are registered to buy the digital asset by respective one or more potential buyers. At step 3130, revenue shares are registered, where the share revenues prescribe portions of sales revenue that are allocated to the publisher.

At step 3140, the one or more registered offers to sell, the one or more registered offers to buy and the registered revenue shares are analyzed, to determine a buy and sell price. At step 3150, the copies of the digital asset from the one or more consumers who have registered offers to sell the asset are purchased at the determined buy price. At step 3160, the purchased assets are sold at the determined sell price to the one or more potential buyers who have registered offers to buy the asset. At step 3170, portion of the sales revenue is allocated to the publisher in accordance with the registered revenue shares.

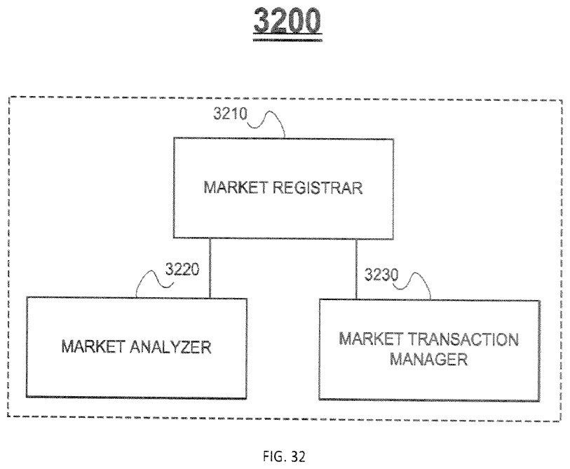

Reference is made to FIG. 32, which is a simplified block diagram of a system for creating a market for digital assets, in accordance with an embodiment of the present invention. Shown in FIG. 32 is a market registrar 3210, a market analyzer 3220 and a market transaction manager 3230.

Market registrar 3210 registers one or more offers to sell a digital asset published by a publisher, by respective one or more consumers who own the digital asset and who have obtained permission from the publisher to sell the digital asset at a price range specified by the publisher. Market registrar 3210 also registers one or more offers to buy the digital asset by respective one or more potential buyers. Market registrar 3210 also registers revenue shares that prescribe portions of sales revenue that are allocated to the publisher.

Market analyzer 3220 analyzes the one or more registered offers to sell, the one or more registered offers to buy and the registered revenue shares, to determine a buy and sell price.

Market transaction manager 3230 purchases, at the determined buy price, copies of the digital asset from the one or more consumers who have registered offers to sell the asset. Market transaction manager 3230 also sells, at the determined sell price, the purchased assets to the one or more potential buyers who have registered offers to buy the asset. Market transaction manager 3230 also allocates a portion of the sales revenue to the publisher in accordance with the registered revenue shares.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

1-76. (canceled)

77. A computing data processing computer system comprising:
a communication layer, comprising client web services managing communication with client computers, comprising:
a message parser performing lexical analysis on incoming messages by dividing the messages into component parts;
a message validator determining whether the message is constructed as per the protocol defined for the client web services; and
a message authenticator authenticating the body of the message and the sender of the message;
a non-transitory computer storage device storing records of title for digital assets; and
a computing engine layer, comprising a registrar that (i) registers purchase of a digital asset on a first device by a first consumer or by a first entity that buys and sells digital assets, (ii) generates a dated record of title to the first consumer or to the first entity, respectively, for the digital asset, and stores the dated record of title on said non-transitory computer storage device, (iii) receives a resale permission message for the digital asset from the first consumer or from the first entity, via said client web services, whereby the permission message is parsed, validated, and authenticated by said client web services, (iv) further registers purchase of the digital asset on a second device by either a second consumer, or by a second entity that buys and sells digital assets, and (v) further generates an updated record of title for the digital asset to the second consumer, or to the second entity, respectively, and stores the updated record of title on said non-transitory computer storage device.

78. The computing system of claim 77 wherein said communication layer further comprises partner web services managing communication with entities that receive disbursements from the system, and wherein said computing engine layer further comprises a disbursement manager that (i) determines an allocation of cash or purchasing credit, of a purchase price paid by the second consumer or the second entity, for the digital asset, between one or more of the first consumer or the first entity, a publisher of the digital asset, and the registrar, and (ii) transmits the allocation to one or more of the first consumer or the first entity via said partner web services.

79. The computing system of claim 77 where said computing engine layer automatically generates the resale permission when a designated time period has expired from the date of the record of title to the first consumer or the first entity, and/or a designated date has arrived.

80. The computing system of claim 77 wherein said registrar repeatedly performs (iii), (iv) and (v) for a succession of consumers or entities that buy and sell digital assets.

81. The computing system of claim 77 wherein said computing engine layer further comprises multiple back-end nodes, each of which services devices that communicate with the system, wherein each instance of a back-end node comprises:
a web services layer;
a business logic layer; and
a node synchronization manager.

82. The computing system of claim 77 further comprising a database layer interacting with said computing engine layer.
